(19) United States
(12) Patent Application Publication
(10) Pub. No.: US 2021/0125220 A1
(43) Pub. Date: Apr. 29, 2021

(54) EXPECTED REVENUE THRESHOLD DETERMINATION

(71) Applicant: Oath Inc., New York, NY (US)

(72) Inventors: Alexander Zlotnik, Haifa (IL); Yair Koren, Haifa (IL); Abraham Shahar, Tel Aviv (IL); Dror Porat, Tel Aviv (IL)

(21) Appl. No.: 16/661,021

(22) Filed: Oct. 23, 2019

(51) Int. Cl. G06Q 30/02

(52) U.S. Cl. CPC G06Q 30/0247; G06Q 30/0246; G06Q 30/0201

(57) ABSTRACT

One or more computing devices, systems, and/or methods for determining expected revenue thresholds for presentation of content items via client devices are provided. During a first period of time, whether to present a first content item via a first client device may be determined based upon a comparison of a first expected revenue associated with the first content item with a first expected revenue threshold. A first revenue value associated with presentation of content items via client devices within the first period of time may be determined. The first expected revenue threshold may be modified to generate a second expected revenue threshold based upon the first revenue value and a target revenue value. Whether to present a second content item via a second client device may be determined based upon a comparison of a second expected revenue associated with the second content item with the second expected revenue threshold.

### BACKGROUND

Many applications, such as websites, applications, etc. may provide platforms for viewing media. For example, a user may interact with a service. While interacting with the service, selected media may be presented to the user automatically.

### SUMMARY

In accordance with the present disclosure, one or more computing devices and/or methods are provided. In an example, a first request for content associated with a first client device may be received during a first period of time. In some examples, it is determined that a first expected revenue threshold is associated with the first request for content based upon the first request for content. In some examples, a first plurality of bid values associated with a first plurality of content items is determined. A bid value of the first plurality of bid values may be associated with a content item of the first plurality of content items. In some examples, a first plurality of expected revenues associated with the first plurality of content items is determined based upon the first plurality of bid values. An expected revenue of the first plurality of expected revenues may be associated with a content item of the first plurality of content items. In some examples, whether to present a first content item of the first plurality of content items via the first client device is determined based upon a comparison of a first expected revenue associated with the first content item with the first expected revenue threshold. In some examples, a first revenue value associated with presentation of content items via client devices within the first period of time is determined. In some examples, the first expected revenue threshold associated with the first request for content is modified, based upon the first revenue value and a target revenue value, to generate a second expected revenue threshold. In some examples, a second request for content associated with a second client device is received. In some examples, it is determined that the second request for content is associated with the second expected revenue threshold based upon the second request for content. In some examples, a second plurality of bid values associated with a second plurality of content items is determined. A bid value of the second plurality of bid values may be associated with a content item of the second plurality of content items. In some examples, a second plurality of expected revenues associated with the second plurality of content items is determined based upon the second plurality of bid values. An expected revenue of the second plurality of expected revenues may be associated with a content item of the second plurality of content items. In some examples, whether to present a second content item of the second plurality of content items via the second client device is determined based upon a comparison of a second expected revenue associated with the second content item with the second expected revenue threshold.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4A is a first portion of a flow chart illustrating an example method for determining expected revenue thresholds for presentation of content items via client devices.

FIG. 4B is a second portion of a flow chart illustrating an example method for determining expected revenue thresholds for presentation of content items via client devices.

FIG. 5A is a component block diagram illustrating an example system for determining expected revenue thresholds for presentation of content items via client devices, where, during a first period of time, a content serving system associated with a content system provides content items for presentation via client devices and/or one or more first internet resources associated with a first entity.

FIG. 5B is a component block diagram illustrating an example system for determining expected revenue thresholds for presentation of content items via client devices, where a second expected revenue threshold is determined.

FIG. 5C is a component block diagram illustrating an example system for determining expected revenue thresholds for presentation of content items via client devices, where, during a second period of time, a content serving system associated with a content system provides content items for presentation via client devices and/or one or more first internet resources associated with a first entity.

FIG. 6A is a component block diagram illustrating an example system for determining whether to present a content item via a client device based upon a comparison of an expected revenue associated with the content item with an expected revenue threshold, where a client device presents and/or accesses a first webpage using a browser of the client device.

FIG. 6B is a component block diagram illustrating an example system for determining whether to present a content item via a client device based upon a comparison of an expected revenue associated with the content item with an expected revenue threshold, where a client device presents a plurality of search results associated with a query using a browser of the client device.

FIG. 6C is a component block diagram illustrating an example system for determining whether to present a content item via a client device based upon a comparison of an expected revenue associated with the content item with an expected revenue threshold, where a client device transmits a request to access a resource to a first server.

FIG. 6D is a component block diagram illustrating an example system for determining whether to present a content item via a client device based upon a comparison of an expected revenue associated with the content item with an expected revenue threshold, where a first server transmits a request for content to a second server associated with a content system.

FIG. 6E is a component block diagram illustrating an example system for determining whether to present a content item via a client device based upon a comparison of an expected revenue associated with the content item with an expected revenue threshold, where a backend system determines whether to provide a content item for presentation via a second client device and/or a fourth webpage.

FIG. 6F is a component block diagram illustrating an example system for determining whether to present a content item via a client device based upon a comparison of an expected revenue associated with the content item with an expected revenue threshold, where a client device presents and/or accesses a fourth webpage using a browser of the client device.

FIG. 7 is an illustration of a scenario featuring an example non-transitory machine readable medium in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

### 1. Computing Scenario

The following provides a discussion of some types of computing scenarios in which the disclosed subject matter may be utilized and/or implemented.

1.1. Networking

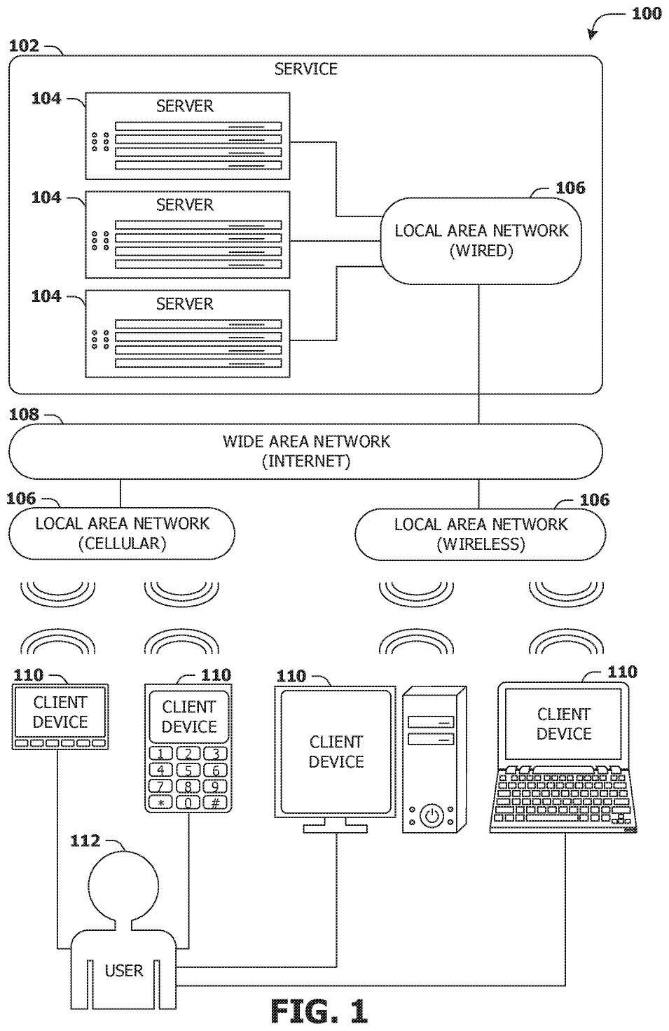

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

1.2. Server Configuration

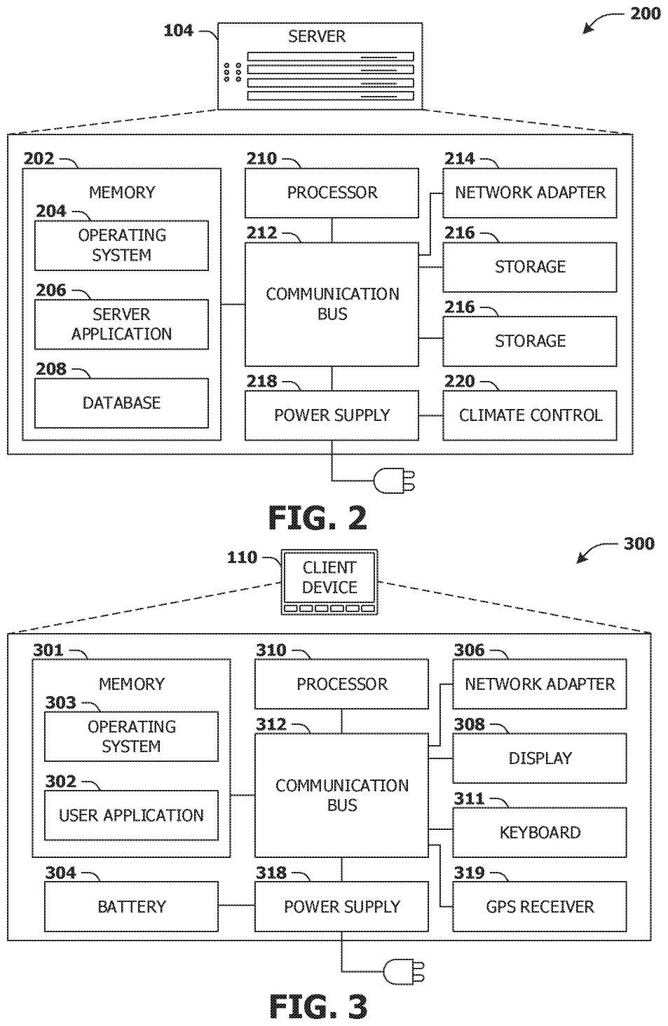

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

### 2. Presented Techniques

One or more computing devices and/or techniques for determining expected revenue thresholds for presentation of content items via client devices are provided. For example, a content system may provide content items for presentation via one or more internet resources such as one or more of one or more websites, one or more webpages, one or more applications (e.g., one or more mobile applications), etc. associated with an entity (e.g., one or more of an internet publisher, a company, a business, an organization, etc.). In some examples, the entity may receive compensation for allowing the content system to present content items via the one or more internet resources. For example, the content system may correspond to an advertisement system and/or the content items may correspond to advertisements. Alternatively and/or additionally, the entity may access and/or interact with a service, such as an advertising service, that provides a platform for uploading information to the content system. In some examples, the information may be indicative of a target revenue. The target revenue may correspond to a target average revenue per content item presentation. Alternatively and/or additionally, the target revenue may correspond to a target average revenue per multiple content item presentations. In some examples, the content system may present content items for presentation via the one or more internet resources associated with the entity based upon the target revenue such that an average revenue per content item and/or an average revenue per multiple content items meet (e.g., are greater than or equal to) the target average revenue per content item presentation and/or the target average revenue per multiple content item presentations.

For example, responsive to receiving a request for content associated with the one or more internet resources, a plurality of bid values associated with a plurality of content items may be determined. A bid value of the plurality of bid values may be associated with a content item of the plurality of content items. A plurality of expected revenues associated with the plurality of content items may be determined based upon the plurality of bid values. An expected revenue of the plurality of expected revenues may be associated with a content item of the plurality of content items. In some examples, a first content item, of the plurality of content items, may be selected based upon the plurality of expected revenues (e.g., the first content item may be associated with a first expected revenue that is a highest expected revenue of the plurality of expected revenues). In some examples, whether to present the first content item via a first client device associated with the request for content may be determined based upon a comparison of the first expected revenue with a first expected revenue threshold. For example, the first content item may be transmitted to the first client device responsive to a determination that the first expected revenue exceeds the first expected revenue threshold. Alternatively and/or additionally, the first content item may not be transmitted to the first client device responsive to a determination that the first expected revenue is less than the first expected revenue threshold.

In some existing systems, the first expected revenue threshold may correspond to the target revenue. Alternatively and/or additionally, the first expected revenue threshold may correspond to the target average revenue per content item presentation. For example, if the target revenue corresponds to 0.2 per content item presentation (e.g., $0.20 revenue per content item presentation), the first expected revenue threshold may be equal to 0.2. Further, in those systems, the first expected revenue threshold may not change over time. Accordingly, content items associated with expected revenues less than 0.2 may not be provided for presentation via client devices. However, a request for content may be received for which a plurality of content items associated with the request for content are identified and/or a plurality of expected revenues associated the plurality of content items are determined, where a highest expected revenue of the plurality of expected revenues does not exceed the first expected revenue threshold. Thus, a content item may not be provided for presentation via a client device based upon the request for content, which may result in less revenue being received. Further, an average revenue per content item associated with presentation of content items via client devices may exceed the target average revenue per content item by a first difference. Due to not providing content items associated with expected revenues less than the first expected revenue threshold (e.g., 0.2), the first difference may be large (e.g., the average revenue per content item presentation may be 0.3 and/or the target average revenue per content item presentation may correspond to 0.2). By changing and/or updating the first expected revenue threshold (e.g., reducing the first expected revenue threshold from 0.2 to 0.15), more content items may be provided for presentation (and/or fewer content items may be associated with expected revenues less than the first expected revenue threshold), which may result in an increase in received revenue.

Thus, in accordance with one or more of the techniques presented herein, an expected revenue threshold may be configured such that the average revenue per content item exceeds the target average revenue per content item. Alternatively and/or additionally, the expected revenue threshold may be configured such that the average revenue per content item does not exceed the target average revenue per content item by a large difference. The expected revenue threshold may be modified (e.g., updated) periodically. For example, a first average revenue per content item (and/or per multiple content items) associated with presentation of content items via client devices within a first period of time may be determined, wherein the presentation of the content items via the client devices is performed using a first expected revenue threshold. The first expected revenue threshold may be modified based upon the first average revenue per content item and/or the target average revenue per content item to generate a second expected revenue threshold. For example, the second expected revenue threshold may be used for presentation of content items via client devices. The first expected revenue threshold may be increased to generate the second expected revenue threshold (e.g., the second expected revenue threshold may be greater than the first expected revenue threshold) based upon a determination that the first average revenue per content item is less than a first value associated with the target average revenue per content item (e.g., the first value may be greater than or equal to the target average revenue per content item). Alternatively and/or additionally, the first expected revenue threshold may be decreased to generate the second expected revenue threshold (e.g., the second expected revenue threshold may be less than the first expected revenue threshold) based upon a determination that the first average revenue per content item is greater than the first value associated with the target average revenue per content item.

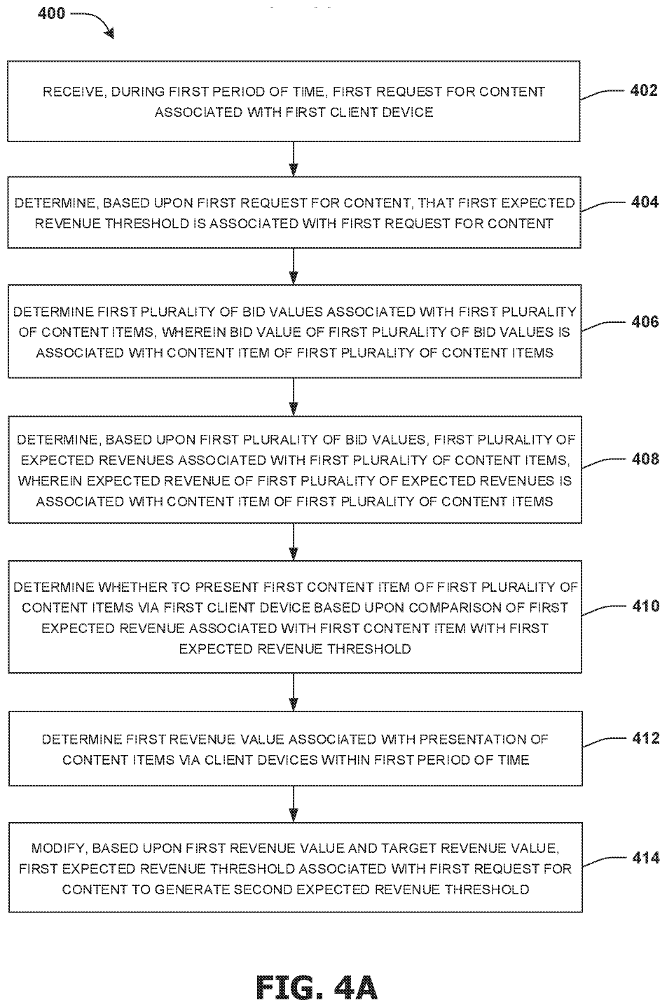

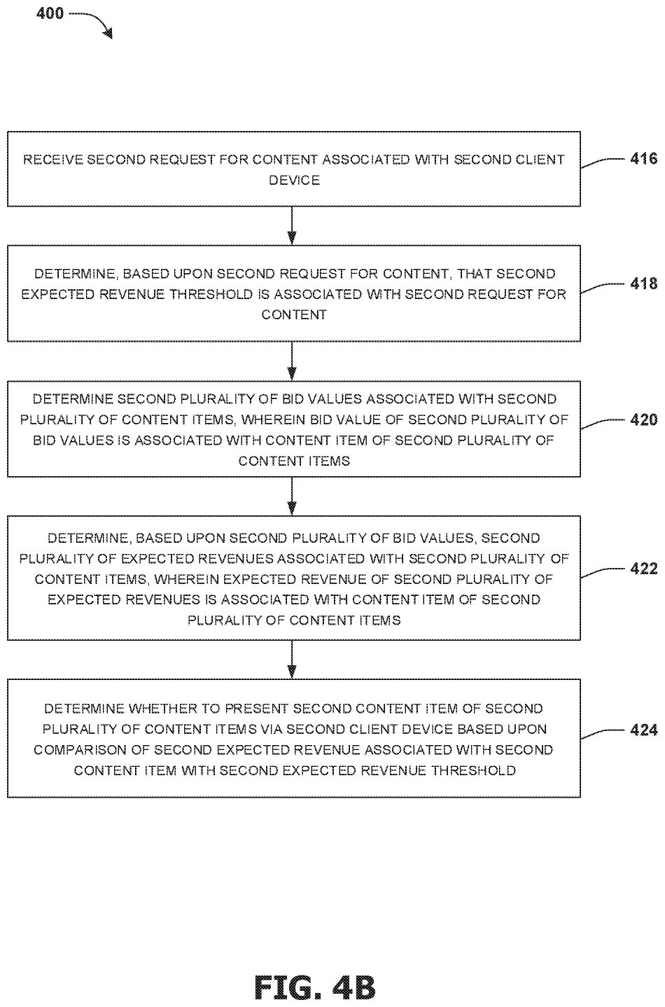

An embodiment of determining expected revenue thresholds for presentation of content items via client devices is illustrated by an example method 400 of FIGS. 4A-4B. In some examples, a content system may provide content items (e.g., one or more of images, videos, audio, interactive graphical objects, advertisements, etc.) for presentation via one or more first internet resources such as one or more of one or more websites, one or more webpages, one or more applications (e.g., one or more mobile applications), etc. associated with a first entity (e.g., one or more of an internet publisher, a company, a business, an organization, etc.). For example, the first entity may correspond to one or more of an owner, a provider, a publisher, etc. of the one or more first internet resources. In some examples, the first entity may receive compensation (e.g., commission) in exchange for the content system presenting content items via the one or more first internet resources. Alternatively and/or additionally, a content entity associated with the content system and/or the first entity may receive compensation (e.g., revenue) from entities associated with content items in exchange for the content system providing the content items for presentation via the one or more first internet resources.

In some examples, the content system may be an advertisement system. Alternatively and/or additionally, the content system may not be an advertisement system. The content system may provide content items to be presented via pages associated with the content system. For example, the pages may be associated with websites (e.g., search engine websites, email service websites, news content websites, communication service websites, video platform websites, multimedia platform websites, etc.) associated with the content system. The content system may provide content items to be presented in (dedicated) locations throughout the pages (e.g., one or more areas of the pages configured for presentation of content items). For example, a content item may be presented at the top of a webpage associated with the content system (e.g., within a banner area), at the side of the webpage (e.g., within a column), in a pop-up window, overlaying content of the webpage, etc. Alternatively and/or additionally, a content item may be presented within an application (e.g., a mobile application) associated with the content system and/or within a game associated with the content system. Alternatively and/or additionally, a user may be required to watch and/or interact with the content item before the user can access content of a webpage, utilize resources of an application and/or play a game.

In some examples, a first target revenue value may be determined for presentation of content items via the one or more first internet resources. In some examples, the first target revenue value may correspond to a first target average revenue per content item presentation associated with the one or more first internet resources. In some examples, a content item presentation associated with the one or more first internet resources may correspond to the content system providing a content item for presentation via an internet resource of the one or more first internet resources on a client device that accesses the internet resource. Alternatively and/or additionally, the first target revenue value may correspond to a first target average cost per impression associated with the one or more first internet resources. In some examples, an impression associated with the one or more first internet resources corresponds to a content item, provided by the content system, being displayed and/or presented via an internet resource of the one or more first internet resources on a client device that access the internet resource. In an example, the first target revenue value may be equal to 0.02. For example, the first target revenue value may be indicative of a target average revenue of $0.02 (e.g., 2 cents) per content item presentation associated with the one or more first internet resources (and/or a target average revenue of $0.02 per content item impression associated with the one or more first internet resources).

Alternatively and/or additionally, the first target revenue value may correspond to a first target average revenue per multiple content item presentations (e.g., one or more of 100 content item presentations, 1000 content item presentations, 2000 content item presentations, etc.) associated with the one or more first internet resources. Alternatively and/or additionally, the first target average revenue value may correspond to a first target average cost per multiple impressions, such as a target average cost per 1000 impressions (e.g., Cost per Mille (CPM)), associated with the one or more first internet resources. In an example, the first target revenue value may be equal to 2. For example, the first target revenue value may be indicative of a target average revenue of $2.00 per 1000 content item presentations associated with the one or more first internet resources (and/or a target average revenue of $2.00 per 1000 content item impressions associated with the one or more first internet resources).

In some examples, the first target revenue value may be determined based upon received information. For example, the first entity may access and/or interact with a content interface associated with the content system to upload entity information to the content system. The content interface may be accessed via a client device associated with the entity. Alternatively and/or additionally, the entity information may be received from the client device associated with the first entity. In some examples, the entity information may be indicative of an entity target revenue value.

In some examples, the first target revenue value may be determined based upon the entity target revenue value. For example, the entity target revenue value may be equal to the first target revenue value. Alternatively and/or additionally, the entity target revenue value may comprise the first target average revenue per content item presentation, the first target average cost per impression, the first target average revenue per multiple content item presentations and/or the first target average cost per multiple impressions.

Alternatively and/or additionally, the entity target revenue value may be different than the first target revenue value. For example, the entity target revenue value may comprise one or more of a second target average revenue per content item presentation associated with the one or more first internet resources different than the first target average revenue per content item presentation, a second target average cost per impression associated with the one or more first internet resources different than the first target average cost per impression, a second target average revenue per multiple content item presentations associated with the one or more first internet resources different than the first target average revenue per multiple content item presentations and/or a second target average cost per multiple impressions associated with the one or more first internet resources different than the first target average cost per multiple impressions.

In some examples, the entity target revenue value may be associated with first revenue received by the first entity (e.g., the compensation (e.g., commission) received by the first entity in exchange for the content system presenting content items via the one or more first internet resources), which may be different than a total revenue received by the first entity and/or the content entity associated with the content system. For example, the first revenue may be a portion and/or a percentage of the total revenue. Alternatively and/or additionally, the first target revenue value may be associated with the total revenue received by the first entity and/or the content entity.

One or more operations (e.g., mathematical operations) may be performed using the entity target revenue value to determine the first target revenue value. For example, one or more operations (e.g., mathematical operations) may be performed using the second target average revenue per content item presentation, the second target average cost per impression, the second target average revenue per multiple content item presentations and/or the second target average cost per multiple impressions to determine the first target revenue value (e.g., the first target average revenue per content item presentation, the first target average cost per impression, the first target average revenue per multiple content item presentations and/or the first target average cost per multiple impressions).

At 402, during a first period of time, a first request for content associated with a first client device may be received. In some examples, the first request for content may be received responsive to the first client device accessing a first internet resource, of the one or more first internet resources associated with the first entity. For example, the first client device may transmit a request to access the first internet resource to a server associated with the first internet resource. Responsive to receiving the request to access the first internet resource, the server associated with the first internet resource may transmit the first request for content to the content system (and/or to a server associated with the content system). Alternatively and/or additionally, the first request for content may be received from the first client device. In some examples, the first request for content may correspond to a request to be provided with a content item (e.g., an advertisement, an image, a link, a video, etc.) for presentation via the first internet resource.

At 404, it may be determined based upon the first request for content that a first expected revenue threshold is associated with the first request for content. In some examples, the first expected revenue threshold is associated with the first target revenue value. Alternatively and/or additionally, the first request for content may be analyzed to determine that the first request for content is associated with the first expected revenue threshold and/or the first target revenue value.

In some examples, the first request for content may comprise an indication of the first target revenue value. For example, it may be determined that the first request for content is associated with the first target revenue value and/or the first expected revenue threshold responsive to analyzing the first request for content to identify the indication of the first target revenue value within the first request for content.

In some examples, it may be determined that the first request for content is associated with the first target revenue value and/or the first expected revenue threshold based upon a determination that one or more characteristics associated with the first request for content correspond to one or more characteristics of a first set of request characteristics associated with the first target revenue value. Alternatively and/or additionally, the first set of request characteristics may be determined based upon the entity information (received from the client device associated with the first entity). For example, the entity information may be indicative of the first set of request characteristics.

In some examples, the first set of request characteristics may be indicative of one or more of the one or more first internet resources, one or more first regions (e.g., one or more countries, one or more states, one or more provinces, one or more cities, etc.), one or more first types of client devices (e.g., one or more of a tablet, a phone, a laptop, a tablet model, a phone model, a laptop model, etc.), one or more first user demographics (e.g., one or more of an age range, a household size, a gender, etc.), one or more first geolocations, etc.

In some examples, the one or more first internet resources may correspond to one or more of one or more websites, one or more sections of the one or more websites (e.g., the one or more sections may correspond to one or more (dedicated) locations of the one or more websites, such as one or more of a banner area, a column, an area for presenting content items provided by the content system, a popup window, etc.), one or more webpages, one or more sections of the one or more webpages, one or more applications (e.g., one or more mobile applications), one or more sections of the one or more applications, etc.

In some examples, the first request for content may be analyzed to determine the first internet resource associated with the first request for content. In some examples, the first request for content may be indicative of the first internet resource (e.g., the first request for content may be indicative of a web address associated with a webpage and/or an application and/or the first request for content may be indicative of a section of the webpage and/or the application). In some examples, it may be determined that the first target revenue value and/or the first expected revenue threshold are associated with the first request for content based upon a determination that the first internet resource matches an internet resource of the one or more first internet resources of the first set of request characteristics. For example, the first internet resource may correspond to a webpage, a section of the webpage, an application and/or a section of the application of the one or more first internet resources.

In some examples, the first request for content may be analyzed to determine a first region associated with the first request for content. For example, the first region may correspond to a region in which the first client device is located. Alternatively and/or additionally, the first region may correspond to a region in which a network node that the first request for content is received from is located. Alternatively and/or additionally, the first region may correspond to a region in which a network node that the request to access the first internet resource is received from is located. In some examples, the first request for content is indicative of the first region. In some examples, it may be determined that the first target revenue value and/or the first expected revenue threshold are associated with the first request for content based upon a determination that the first region matches a region of the one or more first regions of the first set of request characteristics.

In some examples, the first request for content may be analyzed to determine a first type of client device associated with the first request for content. For example, the first type of client device may correspond to a type of client device of the first client device (e.g., one or more of a tablet, a phone, a laptop, a tablet model, a phone model, a laptop model, etc.). In some examples, the first request for content is indicative of the first type of client device. In some examples, it may be determined that the first target revenue value and/or the first expected revenue threshold are associated with the first request for content based upon a determination that the first type of client device matches a type of client device of the one or more first types of client devices of the first set of request characteristics.

In some examples, the first request for content may be analyzed to determine one or more second user demographics associated with the first request for content. For example, the one or more second user demographics may correspond to one or more of an age range of a first user associated with the first client device, a household size of the first user associated with the first client device, a gender of the first user associated with the first client device, etc. In some examples, the first request for content may comprise a client device identifier (e.g., one or more of an IP address, a username, etc.) associated with the first client device. For example, a database of user profiles may be analyzed based upon the client device identifier to identify a first user profile associated with the first client device. In some examples, the first user profile may be indicative of the one or more second user demographics and/or activity information (e.g., search history information, website browsing history, email information, selected content items, etc.) associated with the first client device. In some examples, the one or more second user demographics may be determined based upon the first user profile. In some examples, it may be determined that the first target revenue value and/or the first expected revenue threshold are associated with the first request for content based upon a determination that a user demographic of the one or more second user demographics matches a user demographic of the one or more first user demographics of the first set of request characteristics. In an example, the one or more second user demographics may be indicative of an age of 25 years. Alternatively and/or additionally, the one or more first user demographics of the first set of request characteristics may be indicative of an age range of 24 to 30 years. Thus, a user demographic (e.g., the age of 25 years) of the one or more second user demographics matches a user demographic (e.g., the age range of 24 to 30 years) of the one or more first user demographics of the first set of request characteristics.

In some examples, the first request for content may be analyzed to determine a first geolocation associated with the first request for content. For example, the first geolocation may correspond to a geolocation of the first client device (e.g., a location of the first client device). In some examples, the first request for content is indicative of the first geolocation. In some examples, it may be determined that the first target revenue value and/or the first expected revenue threshold are associated with the first request for content based upon a determination that the first geolocation matches a geolocation of the one or more first geolocations of the first set of request characteristics.

In some examples, a database of target revenue values may comprise a plurality of target revenue values and/or a plurality of sets of request characteristics associated with the plurality of target revenue values. For example, a set of request characteristics of the plurality of sets of request characteristics may be associated with a target revenue value of the plurality of target revenue values. Alternatively and/or additionally, the database of target revenue values may comprise the first set of request characteristics and/or the first target revenue value associated with the first set of request characteristics. Alternatively and/or additionally, the database of target revenue values may be indicative of a plurality of expected revenue thresholds. For example, an expected revenue threshold of the plurality of expected revenue thresholds may be associated with a set of request characteristics of the plurality of sets of request characteristics. Alternatively and/or additionally, the database of target revenue values may comprise the first expected revenue threshold associated with the first set of request characteristics and/or the first target revenue value.

In some examples, responsive to receiving the first request for content, the database of target revenue values may be analyzed based upon the first request for content to identify the first target revenue value and/or the first expected revenue threshold associated with the first request for content. For example, the database of target revenue values may be analyzed based upon one or more of the first internet resource, the first region, the first type of client device, the one or more second user demographics, the first geolocation, etc. to determine that the first request for content is associated with the first target revenue value and/or the first expected revenue threshold.

In some examples, a bidding process may be performed to select a content item from a first plurality of content items participating in an auction for selection of a content item to present via the first client device. At 406, a first plurality of bid values associated with the first plurality of content items may be determined. A bid value of the first plurality of bid values may be associated with a content item of the first plurality of content items. In some examples, the first plurality of bid values may be determined based upon budgets (e.g., daily budgets) and/or target spend patterns associated with the first plurality of content items. For example, the first plurality of bid values and/or the budgets may be received from devices associated with entities (e.g., advertisers, companies, brands, organizations, etc.) associated with the first plurality of content items.

At 408, a first plurality of expected revenues associated with the first plurality of content items may be determined based upon the first plurality of bid values. An expected revenue of the first plurality of expected revenues may be associated with a content item of the first plurality of content items. In some examples, an expected revenue of the first plurality of expected revenues may correspond to (a prediction of) an amount of revenue that may be received as a result of providing a content item of the first plurality of content items for presentation via the first client device and/or the first internet resource.

In some examples, a first exemplary content item of the first plurality of content items may be associated with a pay per click model. Alternatively and/or additionally, an exemplary entity associated with the first exemplary content item may provide compensation to the content entity and/or the first entity if a selection of the first exemplary content item is received responsive to presenting the first exemplary content item via the first client device and/or the first internet resource. For example, an amount of the compensation provided to the content entity and/or the first entity may correspond to a first exemplary bid value, of the plurality of bid values, associated with the first exemplary content item (e.g., if the first exemplary bid value is equal to 0.97, the compensation may correspond to $0.97). Alternatively and/or additionally, the exemplary entity associated with the first exemplary content item may provide compensation to the content entity and/or the first entity if a positive signal is received responsive to presenting the first exemplary content item via the first client device and/or the first internet resource.

In some examples, a first exemplary expected revenue, of the plurality of expected revenues, associated with the first exemplary content item may be determined based upon a first exemplary click probability associated with the first exemplary content item and/or the first exemplary bid value. For example, one or more operations (e.g., mathematical operations) may be performed using the first exemplary bid value and/or the first exemplary click probability to determine the first exemplary expected revenue associated with the first exemplary content item (e.g., the first exemplary bid value may be multiplied by the first exemplary click probability to determine the first exemplary expected revenue). In an example where the first exemplary click probability is 2% and/or the first exemplary bid value is 1 (e.g., $1.00), the first exemplary expected revenue may be equal to 0.02×1=0.02 (e.g., $0.02).

The first exemplary click probability may correspond to a probability of receiving a selection of the first exemplary content item responsive to presenting the first exemplary content item via the first client device and/or the first internet resource. In some examples, the selection of the first exemplary content item may correspond to a click on the first exemplary content item (via the first client device and/or the first internet resource) and/or a tap (e.g., a finger tap on a touchscreen) on the first exemplary content item (via the first client device and/or the first internet resource). Alternatively and/or additionally, the first exemplary click probability may correspond to a probability of receiving a positive signal responsive to presenting the first exemplary content item via the first client device and/or the first internet resource. In some examples, the positive signal may be indicative of the first exemplary content item being consumed by the first user associated with the first client device. Alternatively and/or additionally, the positive signal may be indicative of one or more interactions (e.g., one or more user interactions) with the first exemplary content item (via the first client device and/or the first internet resource). Alternatively and/or additionally, the positive signal may be indicative of the first exemplary content item being presented (and/or the first exemplary content item being presented for longer than a threshold duration of time).

In some examples, the first exemplary click probability associated with the first exemplary content item may be determined and/or predicted based upon one or more of first content information associated with the first exemplary content item (e.g., one or more of one or more first topics associated with the first exemplary content item, one or more products and/or services associated with the first exemplary content item, etc.), first historical information associated with the first exemplary content item (e.g., one or more of a rate at which the first exemplary content item is selected via client devices, a rate at which the first exemplary content item is presented via client devices, etc.), the first user profile, etc. For example, the first exemplary click probability may correspond to a predicted click probability.

In some examples, the first exemplary click probability (and/or other click probabilities associated with other content items of the first plurality of content items) may be determined using a machine learning model and/or using one or more machine learning techniques. For example, the machine learning model may determine the first exemplary click probability (and/or the other click probabilities) based upon one or more of the first user profile, the first content information associated with the first exemplary content item (and/or content information associated with the other content items), the first historical information associated with the first exemplary content item (and/or historical information associated with the other content items), etc.

In some examples, a second exemplary content item of the first plurality of content items may not be associated with a pay per click model. In some examples, a second exemplary entity associated with the second exemplary content item may provide compensation to the content entity and/or the first entity (merely) if the second exemplary content item is presented via the first client device and/or the first internet resource. For example, an amount of the compensation provided to the content entity and/or the first entity may correspond to a second exemplary bid value, of the plurality of bid values, associated with the second exemplary content item. In some examples, a second exemplary expected revenue, of the plurality of expected revenues, associated with the second exemplary content item may be determined based upon the second exemplary bid value. For example, the second exemplary expected revenue may correspond to the second exemplary bid value (e.g., the second exemplary expected revenue may be equal to the second exemplary bid value). In an example, if the second exemplary bid value is 0.02 (e.g., 2 cents), the second exemplary expected revenue may be 0.02 (e.g., 2 cents).

At 410, whether to present a first content item of the first plurality of content items via the first client device and/or the first internet resource may be determined based upon a comparison of the first expected revenue associated with the first content item with the first expected revenue threshold. For example, the first expected revenue associated with the first content item may be compared with the first expected revenue threshold to determine whether the first expected revenue is greater than the first expected revenue threshold or less than the first expected revenue threshold.

In some examples, the first content item may be transmitted to the first client device (and/or the first content item may be provided for presentation via the first client device and/or the first internet resource) responsive to a determination that the first expected revenue associated with the first content item exceeds (and/or is equal to) the first expected revenue threshold. Alternatively and/or additionally, the first content item may not be transmitted to the first client device (and/or the first content item may not be provided for presentation via the first client device and/or the first internet resource) responsive to a determination that the first expected revenue associated with the first content item is less than (and/or equal to) the first expected revenue threshold.

In some examples, the first expected revenue associated with the first content item may be a highest expected revenue of the first plurality of expected revenues (e.g., the first expected revenue may be higher than other expected revenues of the first plurality of expected revenues). For example, the first content item may be selected for presentation via the first client device and/or the first internet resource based upon the first expected revenue being the highest expected revenue of the first plurality of expected revenues.

Alternatively and/or additionally, multiple content items of the first plurality of content items may be selected for presentation via the first client device and/or the first internet resource. For example, the multiple content items may comprise the first content item. In some examples, the multiple content items may be associated with multiple expected revenues, where an expected revenue of the multiple expected revenues is higher than expected revenues of the first plurality of expected revenues, excluding the multiple expected revenues. In some examples, the multiple content items may be selected for presentation via one or more sections of the first internet resource. Alternatively and/or additionally, the first expected revenue associated with the first content item may be a highest expected revenue of the multiple expected revenues (e.g., the first expected revenue may be higher than one or more other expected revenues of the multiple expected revenues associated with the multiple content items).

In some examples, responsive to a determination that the first expected revenue associated with the first content item is less than (and/or equal to) the first expected revenue threshold, the multiple content items may not be transmitted to the first client device (and/or the multiple content items may not be provided for presentation via the first client device and/or the first internet resource).

Alternatively and/or additionally, responsive to a determination that the first expected revenue associated with the first content item exceeds (and/or is equal to) the first expected revenue threshold and/or a determination that a different expected revenue associated with a different content item of the multiple content items is less than (and/or equal to) the first expected revenue threshold, the first content item may be transmitted to the first client device (and/or the first content item may be provided for presentation via the first client device and/or the first internet resource) and/or the different content item may not be transmitted to the first client device (and/or the different content item may not be provided for presentation via the first client device and/or the first internet resource).

In some examples, responsive to a determination that the multiple expected revenues associated with the multiple content items exceed (and/or are equal to) the first expected revenue threshold, the multiple content items may be transmitted to the first client device (and/or the multiple content items may be provided for presentation via the first client device and/or the first internet resource).

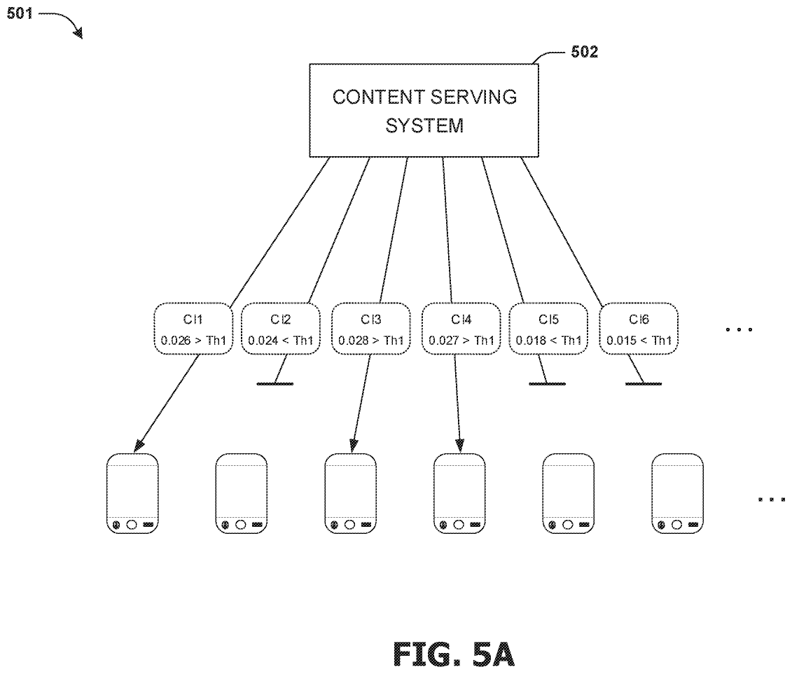

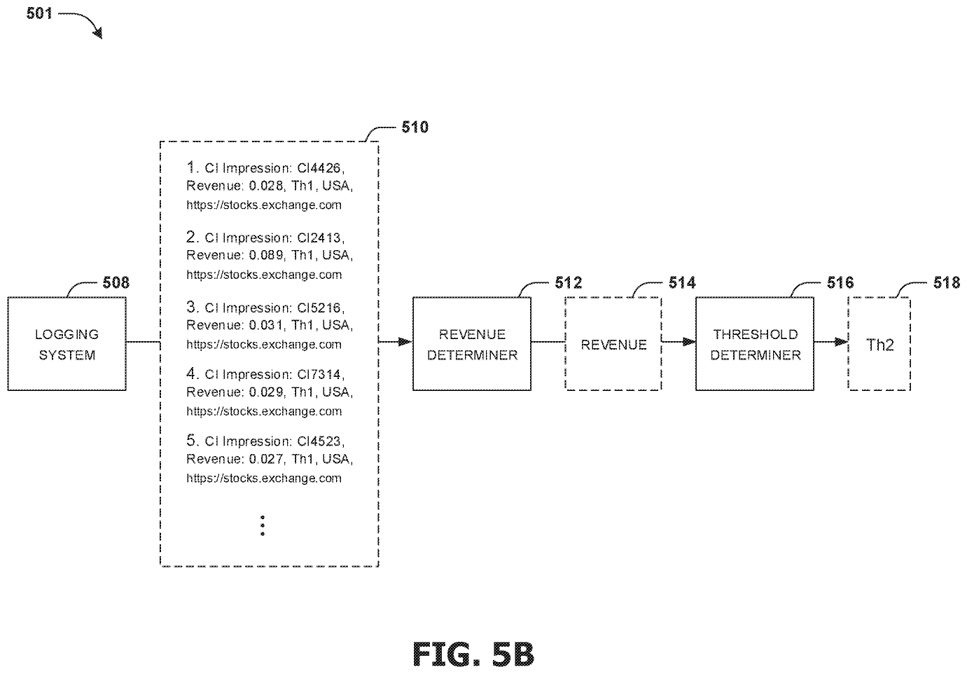

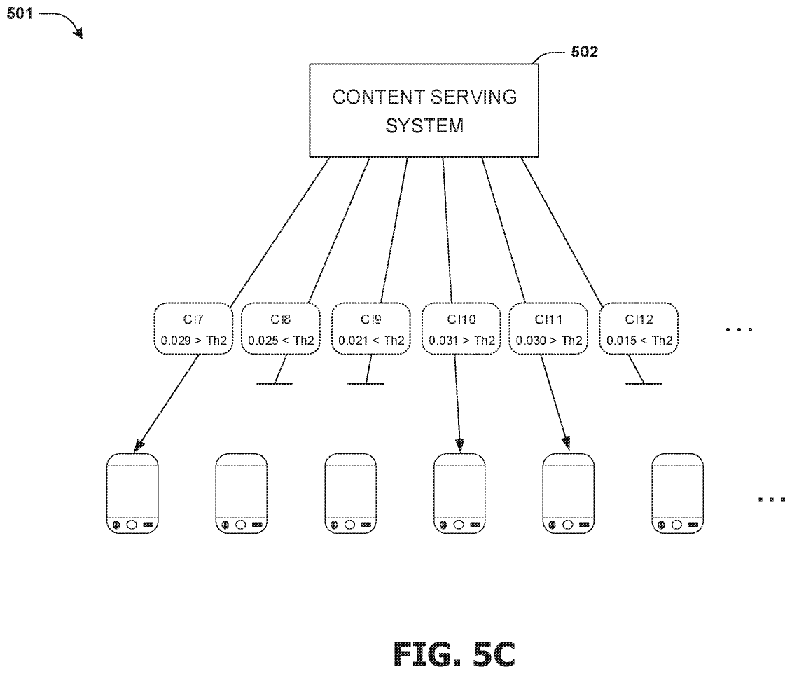

FIGS. 5A-5C illustrate an example system 501 for determining expected revenue thresholds for presentation of content items via client devices. FIG. 5A illustrates a content serving system 502 associated with the content system providing content items for presentation via client devices and/or the one or more first internet resources associated with the first entity during the first period of time. In some examples, the content items may be presented via the client devices responsive to receiving requests for content associated with the first set of request characteristics. Expected revenues associated with content items (e.g., content items CI1, CI2, CI3, CI4, CI5, CI6, etc.) may be compared with the first threshold expected revenue (shown as “Th1” in FIG. 5A) to determine whether to provide the content items for presentation via the client devices and/or the one or more first internet resources associated with the first entity.

In some examples, content items CI1, CI3 and/or CI4 may be provided for presentation via client devices based upon expected revenues associated with the content items CI1, CI3 and/or CI4 exceeding the first expected revenue threshold. In an example, the first expected revenue threshold may be equal to 0.025 and/or a content item CI1 may be associated with an expected revenue equal to 0.026. For example, the content item CI1 may be provided for presentation via a client device based upon the expected revenue associated with the content item CI1 exceeding the first expected revenue threshold.

Alternatively and/or additionally, content items CI2, CI5 and/or CI6 may not be provided for presentation via client devices based upon expected revenues associated with the content items CI2, CI5 and/or CI6 being less than the first expected revenue threshold. In an example, the first expected revenue threshold may be equal to 0.025 and/or a content item CI2 may be associated with an expected revenue equal to 0.024. For example, the content item CI2 may not be provided for presentation via a client device based upon the expected revenue associated with the content item CI2 being less than the first expected revenue threshold.

At 412, a first revenue value associated with presentation of first content items via first client devices within the first period of time may be determined. In some examples, the first content items may be presented via the first client devices responsive to receiving requests for content associated with the first set of request characteristics. Alternatively and/or additionally, a content item of the first content items may be presented via a client device of the first client devices responsive to comparing an expected revenue associated with the content item with the first expected revenue threshold (e.g., the content item may be presented responsive to a determination that the expected revenue associated with the content item exceeds and/or is equal to the first expected revenue threshold). Alternatively and/or additionally, each content item of the first content items may be presented via a client device of the first client devices responsive to comparing an expected revenue associated with the content item with the first expected revenue threshold and/or determining that the expected revenue exceeds and/or is equal to the first expected revenue threshold.

In some examples, the first revenue value may correspond to a first average revenue per content item presentation associated with presentation of the first content items via the first client devices within the first period of time. Alternatively and/or additionally, the first revenue value may correspond to a first average cost per impression associated with presentation of the first content items via the first client devices within the first period of time. Alternatively and/or additionally, the first revenue value may correspond to a first average revenue per multiple content item presentations (e.g., one or more of 100 content item presentations, 1000 content item presentations, 2000 content item presentations, etc.) associated with presentation of the first content items via the first client devices within the first period of time. Alternatively and/or additionally, the first average revenue value may correspond to a first average cost per multiple impressions, such as an average cost per 1000 impressions (e.g., CPM), associated with presentation of the first content items via the first client devices within the first period of time.

In some examples, the first revenue value may be determined based upon a plurality of sets of logged data associated with presentation of the first content items via the first client devices within the first period of time. In some examples, a set of logged data of the plurality of sets of logged data may be indicative of a content item of the first content items being one or more of presented, selected, displayed, etc. via a client device of the first client devices. Alternatively and/or additionally, a set of logged data of the plurality of sets of logged data may be indicative of one or more of a content item identifier of a content item of the first content items, a revenue associated with presentation and/or a selection (and/or an impression) of the content item, an expected revenue threshold applied for presentation of the content item (e.g., the first expected revenue threshold), a region associated with a request for content associated with the content item (e.g., a region of the one or more first regions), an internet resource associated with the request for content (e.g., an internet resource of the one or more first internet resources), a target revenue value associated with the request for content (e.g., the first target revenue value), a type of client device associated with the request for content (e.g., a type of client device of the one or more first types of client devices, one or more user demographics associated with the request for content (e.g., the one or more first user demographics), a geolocation associated with the request for content (e.g., a geolocation of the one or more first geolocations), etc. In some examples, the plurality of sets of logged data may be selected, for determination of the first revenue value, from a second plurality of sets of logged data based upon a determination that the plurality of sets of logged data are associated with one or more of the first expected revenue threshold, the first target revenue value, the one or more first internet resources, the one or more first regions, the one or more first types of client devices, the one or more first user demographics, the one or more first geolocations, etc.

In some examples, the first revenue value may be determined based upon the plurality of sets of logged data. For example, a first total revenue associated with presentation of the first content items via the first client devices may be determined based upon revenues indicated by the plurality of sets of logged data (e.g., the first total revenue may correspond to a sum of the revenues indicated by the plurality of sets of logged data). Alternatively and/or additionally, a first quantity of content item presentations associated with presentation of the first content items via the first client devices may be determined based upon the plurality of sets of logged data. For example, the first quantity of content item presentations may correspond to a quantity of instances that a content item of the first content items is presented via a client device of the first client devices during the first period of time and/or in association with the first set of request characteristics, the first target revenue value, the first expected revenue threshold and/or the one or more first internet resources. Alternatively and/or additionally, the first quantity of content item presentations may correspond to a quantity of sets of logged data of the plurality of sets of logged data.

In some examples, the first revenue value may be determined based upon the first total revenue and/or the first quantity of content item presentations. In an example where the first revenue value corresponds to the first average revenue per content item presentation, the first average revenue per content item presentation may be determined based upon the first total revenue and/or the first quantity of content item presentations. For example, one or more operations (e.g., mathematical operations) may be performed using the first total revenue and/or the first quantity of content item presentations to determine the first average revenue per content item presentation. In an example where the first total revenue is $300.00 and/or the first quantity of content item presentations is 10000, the first average revenue per content item presentation may be determined to be $0.03 (i.e., 300 divided by 10000).

At 414, the first expected revenue threshold may be modified to generate a second expected revenue threshold based upon the first revenue value and/or the first target revenue value. In some examples, the second expected revenue threshold may be applied for presentation of second content items via second client devices within a second period of time (following the first period of time). In some examples, the second expected revenue threshold may be applied based upon identifying requests for content associated with the first set of request characteristics. For example, within the second period of time, the second expected revenue threshold may be compared with expected revenues associated with content items to determine whether to present the content items responsive to receiving requests for content associated with the first set of request characteristics.

In some examples, the first expected revenue threshold may be increased to generate the second expected revenue threshold based upon a determination that the first revenue value is less than (and/or equal to) a first value associated with the first target revenue value. For example, the second expected revenue threshold may be greater than the first expected revenue threshold if the first revenue value is less than (and/or equal to) the first value associated with the first target revenue value.

Alternatively and/or additionally, the first expected revenue threshold may be decreased to generate the second expected revenue threshold based upon a determination that the first revenue value is greater than (and/or equal to) the first value associated with the first target revenue value. For example, the second expected revenue threshold may be less than the first expected revenue threshold if the first revenue value is greater than (and/or equal to) the first value associated with the first target revenue value.

In some examples, the first value associated with the first target revenue value may correspond to the first target revenue value (e.g., the first value may be equal to the first target revenue value). Alternatively and/or additionally, the first value associated with the first target revenue value may be different than the first target revenue value. For example, the first value may be greater than the first target revenue value. In some examples where the first value is different and/or greater than the first target revenue value, the second expected revenue threshold may be modified based upon the first value such that a second revenue value associated with presentation of the second content items within the second period of time is equal to and/or close to the first value. The first value may be greater than the first target revenue value to reduce a probability that the second revenue value associated with presentation of the second content items within the second period of time is less than the first target revenue value (e.g., a risk that the second revenue value is less than the first target revenue value may be reduced as a result of the first value being greater than the first target revenue value and/or as a result of generating the second expected revenue threshold for application during the second period of time based upon the first value, rather than the first target revenue value).

In some examples, the first value associated with the first target revenue value may correspond to a combination of the first target revenue value with a different value. For example, the first value may correspond to a sum of the first target revenue value and the different value (e.g., the first target revenue value may be equal to 3 and/or the different value may be equal to 0.3 such that the first value is equal to 3+0.3=3.3). Alternatively and/or additionally, the first value associated with the first target revenue value may correspond to a product of the first target revenue value and the different value (e.g., the first target revenue value may be equal to 3 and/or the different value may be equal to 1.1 such that the first value is equal to 3×1.1=3.3).

In some examples, a first step may be applied to the first expected revenue threshold to generate the second expected revenue threshold. In some examples, the first step may be combined with (e.g., added to) the first expected revenue threshold to generate the second expected revenue threshold. For example, the second expected revenue threshold may be equal to firstExpectedRevenueThreshold+firstStep. In some examples, the first step may correspond to a positive value if the first revenue value is less than (and/or equal to) the first value associated with the first target revenue value. Alternatively and/or additionally, the first step may correspond to a negative value if the first revenue value is greater than (and/or equal to) the first value associated with the first target revenue value.

Alternatively and/or additionally, a first factor may be applied to the first expected revenue threshold to generate the second expected revenue threshold. In some examples, the first factor may be combined with (e.g., multiplied with) the first expected revenue threshold to generate the second expected revenue threshold. For example, the second expected revenue threshold may be equal to firstExpectedRevenueThreshold×firstFactor. In some examples, the first factor may be greater than 1 if the first revenue value is less than (and/or equal to) the first value associated with the first target revenue value. Alternatively and/or additionally, the first factor may be less than 1 if the first revenue value is greater than (and/or equal to) the first value associated with the first target revenue value.

In some examples, a relationship between the first revenue value and the first target revenue value may be determined. For example, the relationship between the first revenue value may correspond to a ratio and/or a difference associated with the first revenue value and the first target revenue value. Alternatively and/or additionally, the relationship between the first revenue value and the first target revenue value may be equal to

$$\frac{firstRevenueValue}{firstTargetRevenueValue} .$$

In an example where the first revenue value is 3.5 and/or the first target revenue value is 3, the relationship may correspond to 1.17.

In some examples, the second expected revenue threshold may be generated based upon the relationship. In some examples, the first expected revenue threshold may be decreased to generate the second expected revenue threshold based upon the relationship being greater than (and/or equal to) a second value (e.g., 1.1). For example, the second expected revenue threshold may be less than the first expected revenue threshold if the relationship is greater than (and/or equal to) the second value. Alternatively and/or additionally, the first expected revenue threshold may be increased to generate the second expected revenue threshold responsive to the relationship being less than (and/or equal to) the second value. For example, the second expected revenue threshold may be greater than the first expected revenue threshold if the relationship is less than (and/or equal to) the second value.

In some examples where the first step is applied to the first expected revenue threshold to generate the second expected revenue threshold, the first step may correspond to a negative value if the relationship is greater than (and/or equal to) the second value (e.g., if the relationship is greater than 1.1, the first expected revenue threshold may be reduced using the first step to generate the second expected revenue threshold). Alternatively and/or additionally, the first step may correspond to a positive value if the relationship less than (and/or equal to) the second value (e.g., if the relationship is less than 1.1, the first expected revenue threshold may be increased using the first step to generate the second expected revenue threshold).

In some examples, the first step may be between a minimum step value (e.g., −0.2, −0.02, −0.002 and/or a different value) and a maximum step value (e.g., 0.2, 0.02, 0.002 and/or a different value). In some examples, an absolute value of the minimum step value may be equal to the maximum step value. Alternatively and/or additionally, an absolute value of the minimum step value may be different than the maximum step value. For example, if the relationship is less than a first relationship threshold (e.g., 0.8 and/or a different value), the first step may be equal to the maximum step value (e.g., if the relationship is equal to a value between 0 and 0.8, the first step may be equal to 0.2, 0.02, 0.002 and/or a different value corresponding to the maximum step value). Alternatively and/or additionally, if the relationship is greater than a second relationship threshold (e.g., 1.5 and/or a different value), the first step may be equal to the minimum step value (e.g., if the relationship is greater than 1.5, the first step may be equal to −0.2, −0.02, −0.002 and/or a different value corresponding to the minimum step value).

Alternatively and/or additionally, if the relationship is equal to a value between the first relationship threshold (e.g., 0.8) and/or the second value (e.g., 1.1), the first step may be greater than or equal to a second minimum step value (e.g., the second minimum step value may be equal to 0, 0.02, 0.002, 0.005, 0.04 and/or a different value). For example, if the relationship is equal to a value between the first relationship threshold (e.g., 0.8) and/or the second value (e.g., 1.1), the first step may be equal to

$$max ( secondMinmumStepValue , \frac{( relationship - secondValue )}{firstRelationshipThreshold - secondValue} maximumStepValue ) .$$

For example, the first step may be equal to

$$\frac{( relationship - secondValue )}{firstRelationshipThreshold - secondValue} maximumStepValue$$

if

$$\frac{( relationship - secondValue )}{firstRelationshipThreshold - secondValue} maximumStepValue$$

is greater than the second minimum step value. Alternatively and/or additionally, the first step may be equal to the second minimum step value if the second minimum step value is greater than

$$\frac{( relationship - secondValue )}{firstRelationshipThreshold - secondValue} maximumStepValue .$$

In an example where the second minimum step value is equal to 0.02, the relationship is equal to 0.95, the maximum step value is 0.2, the first relationship threshold is equal to 0.8 and/or the second value is equal to 1.1, the first step may be equal to

$$max ( 0.02 , \frac{( 0.95 - 1.1 )}{0.8 - 1.1} 0.2 ) = max ( 0.02 , 0.1 ) = 0.1 .$$

Alternatively and/or additionally, if the relationship is equal to a value between the second relationship threshold (e.g., 1.5) and/or the second value (e.g., 1.1), the first step may be less than or equal to a second maximum step value (e.g., the second maximum step value may be equal to one or more of 0, −0.05, −0.1, etc.). For example, if the relationship is equal to a value between the second relationship threshold (e.g., 1.5) and/or the second value (e.g., 1.1), the first step may be equal to

$$min ( secondMaximumStepValue , \frac{( relationship - secondValue )}{secondRelationshipThreshold - secondValue} \vert minimumStepValue \vert ) .$$

For example, the first step may be equal to

$$\frac{( relationship - secondValue )}{secondRelationshipThreshold - secondValue} \vert minimumStepValue \vert$$

if

$$\frac{( relationship - secondValue )}{secondRelationshipThreshold - secondValue} \vert minimumStepValue \vert$$

is less than the second maximum step value. Alternatively and/or additionally, the first step may be equal to the second maximum step value if the second maximum step value is less than

$$\frac{( relationship - secondValue )}{secondRelationshipThreshold - secondValue} \vert minimumStepValue \vert .$$

In an example where the second maximum step value is equal to −0.05, the relationship is equal to 1.3, the minimum step value is −0.02, the second relationship threshold is equal to 1.5 and/or the second value is equal to 1.1, the first step may be equal to

$$min ( - 0.05 , - \frac{( 1.3 - 1.1 )}{1.5 - 1.1} 0.2 ) = min ( - 0.05 - 0.1 ) = - 0.1 .$$

In some examples, the first step may be increased by a step increase value (e.g., 0.2, 0.02, 0.002 and/or a different value). In some examples, the first step may be increased by the step increase value responsive to determining that the first target revenue value exceeds the first revenue value by a first threshold difference. Alternatively and/or additionally, the first step may be increased by the step increase value responsive to determining that a second revenue associated with the first target revenue value exceeds the first total revenue associated with presentation of the first content items via the first client devices by a second threshold difference.

In some examples, the second revenue may correspond to an amount of revenue associated with presentation of content items, within the first period of time, associated with the first set of request characteristics if the first target revenue value is met. In some examples where the first target revenue value corresponds to the first target average revenue per content item presentation, the second revenue may correspond to a quantity of content item presentations associated with the first set of request characteristics multiplied by the first target average revenue per content item presentation. In an example, if the first target average revenue per content item presentation is equal to 0.01 (e.g., 1 cent) and/or the quantity of content item presentations is equal to 100,000, the second revenue may be equal to 1,000 ($1,000).

Alternatively and/or additionally, responsive to determining that the second revenue exceeds the first total revenue by the second threshold difference (e.g., one or more of $100, $150, $200, etc.), the first step may be increased by the step increase value. For example, responsive to determining that the second revenue exceeds the first total revenue by a first difference, the first difference may be compared with the second threshold difference to determine whether to apply the step increase value to the first step. For example, responsive to determining that the first difference is less than the second threshold difference, the first step may not be increased by the step increase value. Alternatively and/or additionally, responsive to determining that the first difference is greater than the second threshold difference, the first step may be increased by the step increase value.

In some examples, the step increase value may be generated based upon the first difference between the second revenue and the first total revenue. For example, the step increase value may be greater if the first difference is greater. In an example, if the first difference is equal to a first exemplary difference, the step increase value may be equal to a first exemplary value. If the first difference is equal to a second exemplary difference, greater than the first exemplary difference, the step increase value may be equal to a second exemplary value, greater than the first exemplary value. Alternatively and/or additionally, the step increase value may be constant. For example, the first exemplary value may be the same as the second exemplary value.

In some examples where the first factor is applied to the first expected revenue threshold to generate the second expected revenue threshold, the first factor may be less than 1 if the relationship is greater than (and/or equal to) the second value (e.g., if the relationship is greater than 1.1, the first expected revenue threshold may be reduced by multiplying the first expected revenue threshold by the first factor to generate the second expected revenue threshold). Alternatively and/or additionally, the first factor may be greater than 1 if the relationship less than (and/or equal to) the second value (e.g., if the relationship is less than 1.1, the first expected revenue threshold may be increased by multiplying the first expected revenue threshold by the first factor to generate the second expected revenue threshold).

In some examples, the second expected revenue threshold may be less than or equal to the first target average revenue per content item presentation. For example, if the first target average revenue per content item is 0.03, the second expected revenue threshold may be less than or equal to 0.03. In some examples, responsive to determining that a sum of the first expected revenue threshold and the first step exceeds the first target average revenue per content item presentation, the second expected revenue threshold may be set to a maximum expected revenue threshold (e.g., the maximum expected revenue threshold may be less than or equal to the first target average revenue per content item presentation). Alternatively and/or additionally, responsive to determining that a product of the first expected revenue threshold and the first factor exceeds the first target average revenue per content item presentation, the second expected revenue threshold may be set to the maximum expected revenue threshold. Alternatively and/or additionally, the second expected revenue threshold may be greater than the first target average revenue per content item presentation (and/or the maximum expected revenue threshold may be greater than the first target average revenue per content item presentation).

In some examples, responsive to generating the second expected revenue threshold (and/or responsive to the second period of time associated with the second expected revenue threshold beginning), the database of target revenue values may be modified. For example, the second expected revenue threshold may be added to the database of target revenue values (and/or the first expected revenue threshold may be removed from the target revenue values). For example, responsive to modifying the database of target revenue values, the database of target revenue values may be indicative of the first set of request characteristics and/or the first target revenue value being associated with the second expected revenue threshold (during the second period of time).

In some examples, expected revenue thresholds associated with the first set of request characteristics may be updated and/or modified periodically. For example, the second expected revenue threshold may be generated following a duration of time after a previous expected revenue threshold (e.g., the first expected revenue threshold) associated with the first set of request characteristics was generated. Alternatively and/or additionally, the second expected revenue threshold may be generated responsive to determining that a quantity of available sets of logged data of the plurality of sets of logged data (associated with presentation of the first content items via the first client devices within the first period of time) meets a threshold quantity of available sets of logged data (e.g., the quantity of available sets of logged data of the plurality of sets of logged data may be monitored). For example, the threshold quantity of available sets of logged data may correspond to one or more of 100, 1000, 10000, etc. sets of logged data associated with content item presentations associated with the first set of request characteristics. Alternatively and/or additionally, the second expected revenue threshold may be generated responsive to determining that a quantity of content item presentations, of content items associated with the first set of request characteristics being presented following a previous expected revenue threshold (e.g., the first expected revenue threshold) associated with the first set of request characteristics was generated, meets a threshold quantity of content item presentations.

In some examples, the first period of time, during which the first expected revenue threshold is applied for presentation of the first content items via the first client devices, may correspond to a duration of time that is less than a duration of time of a third period of time (e.g., one or more of a first day, a first period of 24 hours, a first week, a first month, etc.). Alternatively and/or additionally, the first period of time may correspond to a first portion of the third period of time (e.g., the third period of time may correspond to the first period of 24 hours and/or the first period of time may correspond to the first portion of the period of 24 hours). Alternatively and/or additionally, the second period of time, for which the second expected revenue threshold is generation is generated, may correspond to a second portion of the third period of time (e.g., the third period of time may correspond to the first period of 24 hours and/or the second period of time may correspond to the second portion of the period of 24 hours following the first portion of the period of 24 hours). Alternatively and/or additionally, the second period of time may not be comprised within the third period of time. For example, the first period of time may correspond to a last portion of the third period of time and/or the second period of time may correspond to an initial portion of a fourth period of time (e.g., one or more of a second day, a second period of 24 hours, a second week, a second month, etc.).

In some examples, revenue values associated with periods of time may be determined periodically (e.g., one or more daily, weekly, monthly, etc.) and/or transmitted to a client device associated with the first entity. For example, a message comprising a third revenue value associated with the third period of time may be transmitted to the client device associated with the first entity. In some examples, the message may be indicative of whether the third revenue value associated with the third period of time meets the first target revenue value. For example, if the third revenue value does not meet the first target revenue value, the content entity may be required to compensate the first entity (e.g., if an average revenue per content item presentation associated with the third period of time does not meet the first target average revenue per content item presentation, the content entity may be required to compensate the first entity). Alternatively and/or additionally, if the third revenue value meets the first target revenue value, the content entity may not be required to compensate the first entity.

In some examples, the third revenue value may be associated with presentation of third content items (comprising the first content items) via third client devices (comprising the first client devices) within the third period of time (comprising the first period of time). In some examples, the third content items may be presented via the third client devices responsive to receiving requests for content associated with the first set of request characteristics. Alternatively and/or additionally, a content item of the third content items may be presented via a client device of the third client devices responsive to comparing an expected revenue associated with the content item with an expected revenue threshold of a plurality of expected revenue thresholds associated with the third period of time. For example, the plurality of expected revenue thresholds may comprise the first expected revenue threshold and/or one or more other expected revenue thresholds associated with one or more other periods of time within the third period of time (e.g., an expected revenue threshold of the plurality of expected revenue thresholds may be generated for each period of time, of a plurality of periods of time, within the third period of time).

In some examples, the third revenue value may correspond to a third average revenue per content item presentation associated with presentation of the third content items via the third client devices within the third period of time. Alternatively and/or additionally, the third revenue value may correspond to a third average cost per impression associated with presentation of the third content items via the third client devices within the third period of time. Alternatively and/or additionally, the third revenue value may correspond to a third average revenue per multiple content item presentations (e.g., one or more of 100 content item presentations, 1000 content item presentations, 2000 content item presentations, etc.) associated with presentation of the third content items via the third client devices within the third period of time. Alternatively and/or additionally, the third average revenue value may correspond to a third average cost per multiple impressions, such as an average cost per 1000 impressions (e.g., CPM), associated with presentation of the third content items via the third client devices within the third period of time.

In some examples, the third revenue value may be determined based upon a third plurality of sets of data associated with presentation of the third content items via the third client devices within the third period of time. In some examples, a set of logged data of the third plurality of sets of logged data may correspond to a content item of the third content items being one or more of presented, selected, displayed, etc. via a client device of the third client devices. In some examples, a third total revenue associated with presentation of the third content items via the third client devices may be determined based upon revenues indicated by the third plurality of sets of logged data. Alternatively and/or additionally, a third quantity of content item presentations associated with presentations of the third content items via the third client devices may be determined based upon the third plurality of sets of logged data. In some examples, the third revenue value may be determined based upon the third total revenue and/or the third quantity of content item presentations.

In some examples, a third expected revenue threshold may be determined based upon the plurality of expected revenue thresholds associated with the third period of time. Alternatively and/or additionally, each expected revenue threshold of the plurality of expected revenue thresholds may be applied within a period of time of the plurality of periods of time within the third period of time. Alternatively and/or additionally, the third expected revenue threshold may be determined by performing one or more operations (e.g., mathematical operations) using the plurality of expected revenue thresholds and/or revenues associated with the plurality of periods of time (e.g., the third expected revenue threshold may correspond to an average expected revenue threshold of the third period of time).

In some examples, the second expected revenue threshold may be determined based upon the third revenue value and/or the third expected revenue threshold. Alternatively and/or additionally, the second expected revenue threshold may be determined based upon the first revenue value, the third revenue value, the first expected revenue threshold and/or the third expected revenue threshold. Alternatively and/or additionally, the third expected revenue threshold may be modified to generate the second expected revenue threshold based upon the third revenue value and/or the first target revenue value.

In some examples, the second expected revenue threshold may be determined based upon the third revenue value and/or the third expected revenue threshold (rather than and/or in addition to determining the second expected revenue threshold based upon the first revenue value and/or the first expected revenue threshold), responsive to a determination that a quantity of content item presentations, of content item presentations associated with the first set of request characteristics during the first period of time, does not meet a threshold quantity of content item presentations. Alternatively and/or additionally, the second expected revenue threshold may be determined based upon the third revenue value and/or the third expected revenue threshold (rather than and/or in addition to determining the second expected revenue threshold based upon the first revenue value and/or the first expected revenue threshold), responsive to a determination that a quantity of sets of logged data of the plurality of sets of logged data (associated with presentation of the first content items via the first client devices within the first period of time) does not meet a threshold quantity of sets of logged data. Alternatively and/or additionally, the second expected revenue threshold may be determined based upon the third revenue value and/or the third expected revenue threshold (rather than and/or in addition to determining the second expected revenue threshold based upon the first revenue value and/or the first expected revenue threshold), responsive to a determination that the third revenue value is less than the first value and/or the first revenue value is greater than the first value.

In some examples, the second expected revenue threshold may be determined based upon the first revenue value and/or the first expected revenue threshold (rather than and/or in addition to determining the second expected revenue threshold based upon the third revenue value and/or the third expected revenue threshold), responsive to a determination that a quantity of content item presentations, of content item presentations associated with the first set of request characteristics during the first period of time, meets the threshold quantity of content item presentations. Alternatively and/or additionally, the second expected revenue threshold may be determined based upon the first revenue value and/or the first expected revenue threshold (rather than and/or in addition to determining the second expected revenue threshold based upon the third revenue value and/or the third expected revenue threshold), responsive to a determination that the quantity of sets of logged data of the plurality of sets of logged data (associated with presentation of the first content items via the first client devices within the first period of time) meets the threshold quantity of sets of logged data.

Alternatively and/or additionally, the second expected revenue threshold may be determined based upon the first revenue value and/or the first expected revenue threshold (rather than and/or in addition to determining the second expected revenue threshold based upon the third revenue value and/or the third expected revenue threshold), responsive to a determination that the first revenue value is less than the first value and/or the third revenue value is greater than the first value. Alternatively and/or additionally, responsive to the determination that the first revenue value is less than the first value and/or the third revenue value is greater than the first value, the first step may be determined based upon the first revenue value, the first target revenue value and/or the relationship between the first revenue value and the first target revenue value using one or more of the techniques presented herein. For example, the first step may correspond to a positive value based upon the first revenue value being less than the first value. In some examples, the first step may be decreased by a tempering value responsive to the determination that the first revenue value is less than the first value and/or the third revenue value is greater than the first value. By decreasing the first step by the tempering value, an increase of the second revenue threshold as compared with the first revenue threshold may be tempered (e.g., reduced) based upon the determination that the third revenue value is greater than the first value (and/or a determination that the first target revenue value is met for the third period of time).

In an example where the second expected revenue threshold is determined based upon the third revenue value and/or the third expected revenue threshold, the third expected revenue threshold may be modified to generate the second expected revenue threshold based upon the third revenue value and/or the first target revenue value. Alternatively and/or additionally, the third expected revenue threshold may be increased to generate the second expected revenue threshold based upon a determination that the third revenue value is less than (and/or equal to) the first value associated with the first target revenue value. Alternatively and/or additionally, the third expected revenue threshold may be decreased to generate the second expected revenue threshold based upon a determination that the first revenue value is greater than (and/or equal to) the first value associated with the first target revenue value.

Alternatively and/or additionally, the first step may be applied to the third expected revenue threshold to generate the second expected revenue threshold using one or more of the techniques presented herein. For example, the first step may be determined based upon the third revenue value, the first target revenue value and/or a second relationship between the third revenue value and/or the first target revenue value (e.g., the first step may correspond to a positive value if the third revenue value is less than (and/or equal to) the first value and/or the first step may correspond to a negative value if the third revenue value is greater than (and/or equal to) the first value). Alternatively and/or additionally, the first step may be increased by the step increase value responsive to determining that a third revenue associated with the first target revenue value exceeds the third total revenue by the first threshold difference. In some examples, the third revenue may correspond to an amount of revenue associated with presentation of content items, within the third period of time, associated with the first set of request characteristics if the first target revenue value is met.

Alternatively and/or additionally, the first factor may be applied to the third expected revenue threshold to generate the second expected revenue threshold using one or more of the techniques presented herein. For example, the first factor may be determined based upon the third revenue value, the first target revenue value and/or the second relationship between the third revenue value and/or the first target revenue value (e.g., the first factor may be greater than 1 if the third revenue value is less than (and/or equal to) the first value and/or the first factor may be less than 1 if the third revenue value is greater than (and/or equal to) the first value).

FIG. 5B illustrates the second expected revenue threshold being determined. In some examples, a logging system 508 may output logged data 510 (e.g., the plurality of sets of logged data and/or the third plurality of sets of logged data) associated with presentation of content items via client devices. In some examples, there may be a delay between a time that a content item is provided for presentation via a client device and a time that a set of logged data corresponding to the content item being presented is available and/or output by the logging system 508.

In some examples, a revenue determiner 512 may determine a revenue value 514 (e.g., the first revenue value associated with the first period of time and/or the third revenue value associated with the third period of time). A threshold determiner 516 may determine an expected revenue threshold 518 “Th2” (e.g., the second expected revenue threshold) based upon the revenue value 514, the first expected revenue threshold and/or the third expected revenue threshold.

FIG. 5C illustrates the content serving system 502 associated with the content system providing content items for presentation via client devices and/or the one or more first internet resources associated with the first entity during the second period of time. In some examples, the content items may be presented via the client devices responsive to receiving requests for content associated with the first set of request characteristics. Expected revenues associated with content items (e.g., content items CI7, CI8, CI9, CI10, CI11, CI12, etc.) may be compared with the second threshold expected revenue (shown as “Th2” in FIG. 5C) to determine whether to provide the content items for presentation via the client devices and/or the one or more first internet resources associated with the first entity.

In some examples, content items CI7, CI10 and/or CI11 may be provided for presentation via client devices based upon expected revenues associated with the content items CI7, CI10 and/or CI11 exceeding the second expected revenue threshold. In an example, the second expected revenue threshold may be equal to 0.027 and/or a content item CI7 may be associated with an expected revenue equal to 0.029. For example, the content item CI7 may be provided for presentation via a client device based upon the expected revenue associated with the content item CI7 exceeding the second expected revenue threshold.

Alternatively and/or additionally, content items CI8, CI9 and/or CI12 may not be provided for presentation via client devices based upon expected revenues associated with the content items CI8, CI9 and/or CI12 being less than the second expected revenue threshold. In an example, the second expected revenue threshold may be equal to 0.027 and/or a content item CI8 may be associated with an expected revenue equal to 0.025. For example, the content item CI8 may not be provided for presentation via a client device based upon the expected revenue associated with the content item CI8 being less than the second expected revenue threshold.

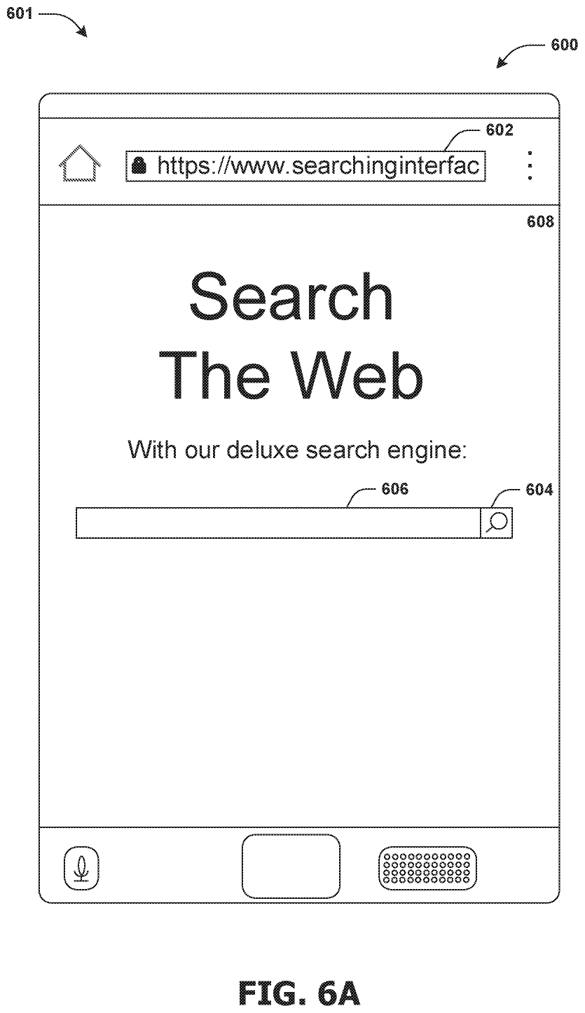

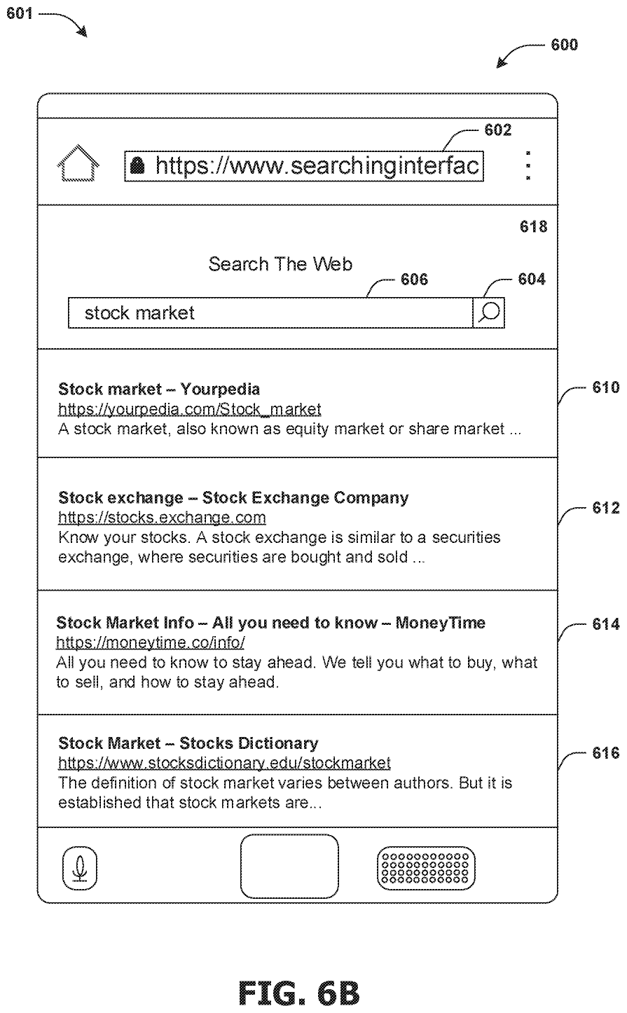

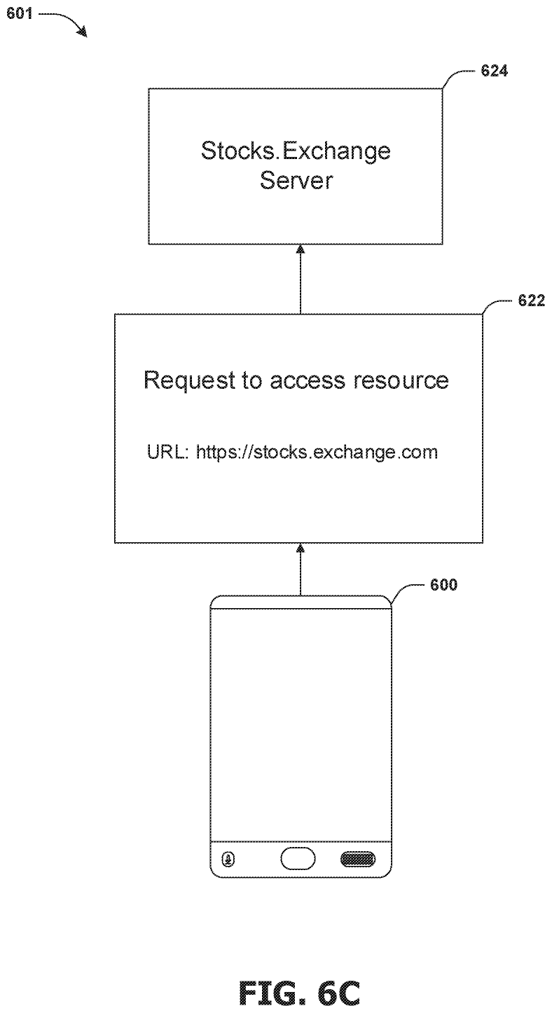

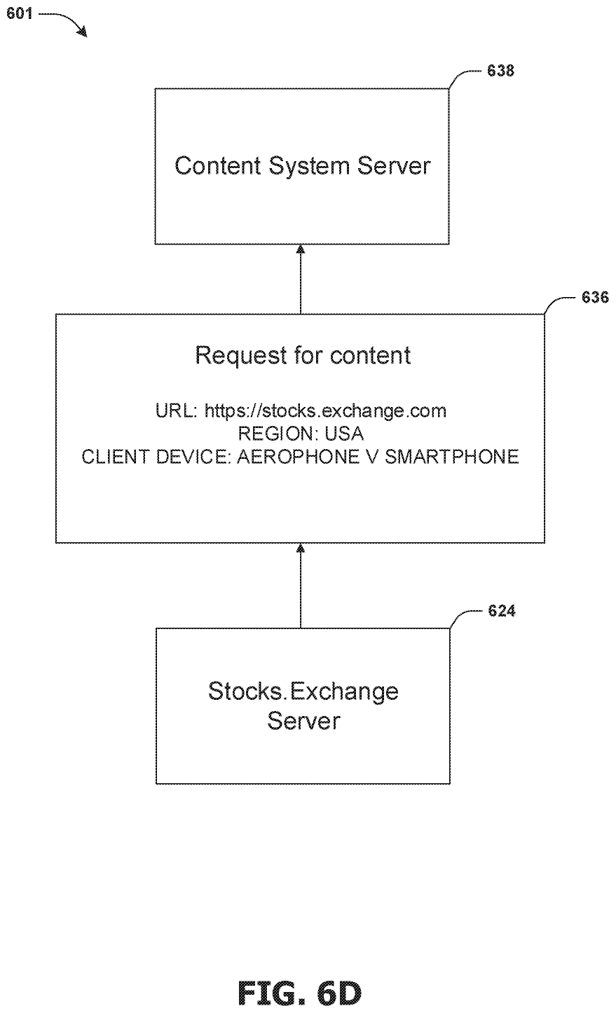

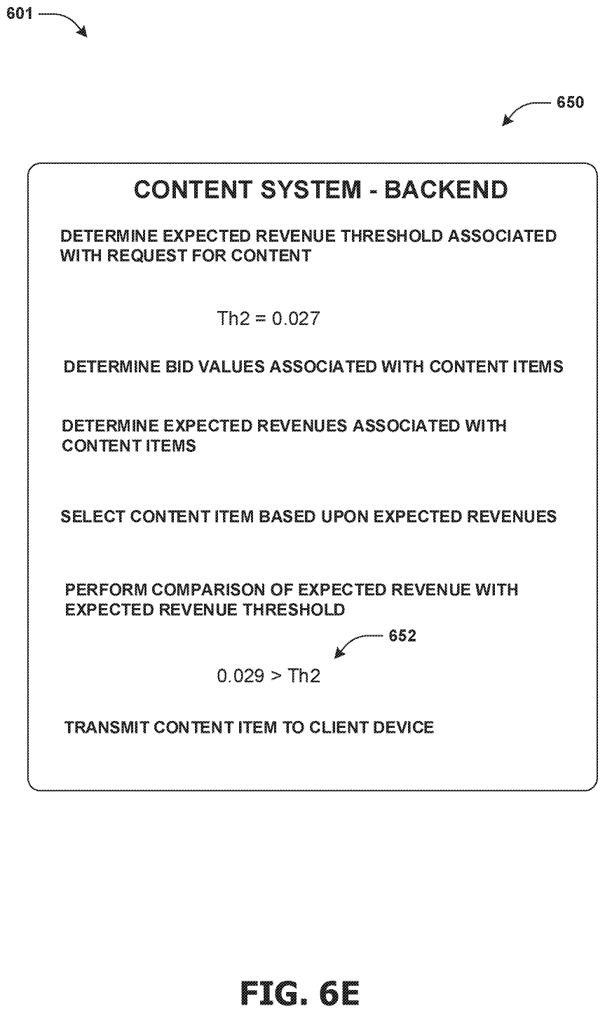

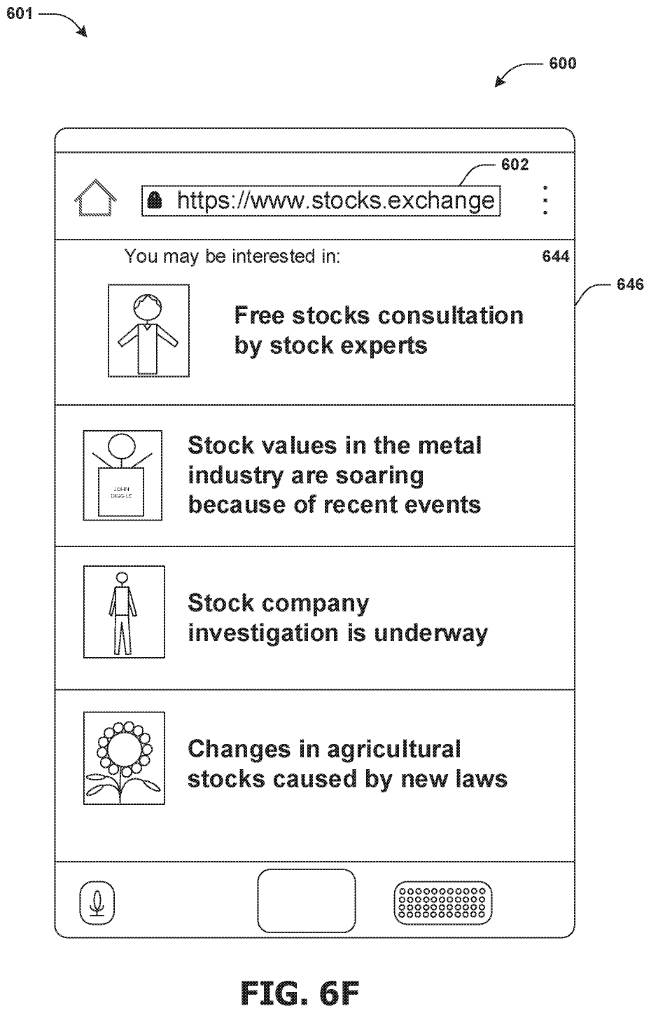

At 416, a second request for content 636 (illustrated in FIG. 6D) associated with a second client device 600 (illustrated in FIG. 6A) may be received within the second period of time.

FIGS. 6A-6F illustrate examples of an example system 601 for determining whether to present a content item via a client device based upon a comparison of an expected revenue associated with the content item with an expected revenue threshold. A second user, such as user Jennifer, (and/or the second client device 600 associated with the second user) may access and/or interact with a service, such as a browser, software, a website, an application, an operating system, an email interface, a messaging interface, a music-streaming application, a video application, etc. that provides a platform for viewing and/or downloading content from a server associated with the content system.

FIG. 6A illustrates the second client device 600 presenting and/or accessing a first webpage 608 using a browser of the second client device 600. The browser may comprise an address bar 602 comprising a web address (e.g., a Uniform Resource Locator (URL)) of the first webpage 608. The first webpage 608 may comprise a search interface. For example, the search interface may comprise a web search engine designed to search for information throughout the internet. In some examples, the first webpage 608 may comprise a search field 606. For example, a query “stock market” may be entered into the search field 606. In some examples, the first webpage 608 may comprise a search selectable input 604 corresponding to performing a search based upon the query. For example, the search selectable input 604 may be selected.

FIG. 6B illustrates the second client device 600 presenting a plurality of search results associated with the query using the browser of the second client device 600. For example, the plurality of search results may be presented within a second webpage 618. For example, the plurality of search results may comprise a first search result 610 corresponding to a third webpage, a second search result 612 corresponding to a fourth webpage 644 (illustrated in FIG. 6F), a third search result 614 corresponding to a fifth webpage and/or a fourth search result 616 corresponding to a sixth webpage. In some examples, the fourth webpage 644 may correspond to an internet resource of the one or more first internet resources associated with the first entity.

In some examples, each search result of the plurality of search results may comprise a selectable input (e.g., a link) corresponding to accessing a webpage associated with the search result. In some examples, the second search result 612 corresponding to the fourth webpage 644 may be selected (e.g., the second search result 612 may be selected via a second selectable input corresponding to the second search result 612).

FIG. 6C illustrates the second client device 600 transmitting a request to access a resource 622 to a first server 624. In some examples, the request to access the resource 622 may be transmitted responsive to the second search result 612 being selected. For example, the resource may correspond to the fourth webpage 644. For example, the request to access the resource 622 may comprise an indication of the fourth webpage 644 (e.g., a web address “https://stocks.exchange.com”). Alternatively and/or additionally, the first server 624 may be associated with the fourth webpage 644.

FIG. 6D illustrates the first server 624 transmitting the second request for content 636 to a second server 638 associated with the content system. In some examples, the second request for content 636 may be transmitted (by the first server 624) responsive to receiving the request to access the resource 622. Alternatively and/or additionally, the second request for content 636 may be transmitted (to the second server 638) by the second client device 600. In some examples, the second request for content 636 may be a request to be provided with a content item (e.g., an advertisement, an image, a link, a video, etc.) (for presentation via the fourth webpage 644). In some examples, the second request for content 636 may comprise an indication of the web address associated with the fourth webpage 644, a second region (e.g., the United States of America) associated with the second request for content 636 and/or a second type of client device (e.g., “Aerophone V smartphone”) of the second client device 600.

FIG. 6E illustrates a backend system 650 (of the content system) determining whether to provide a content item for presentation via the second client device 600 and/or the fourth webpage 644 based upon a comparison of an expected revenue associated with the content item with the second expected revenue threshold.

At 418, it may be determined (by the backend system 650) that the second expected revenue threshold is associated with the second request for content 636. In some examples, the second request for content 636 may comprise an indication of the first target revenue value. For example, it may be determined that the second request for content 636 is associated with the first target revenue value and/or the second expected revenue threshold responsive to analyzing the second request for content 636 to identify the indication of the first target revenue value within the second request for content 636.

Alternatively and/or additionally, it may be determined that the first target revenue value and/or the second expected revenue threshold are associated with the second request for content 636 based upon a determination that the second request for content 636 is associated with the first set of request characteristics associated with the first target revenue value. For example, it may be determined that the first target revenue value and/or the second expected revenue threshold are associated with the second request for content 636 based upon a determination that the fourth webpage 644 matches an internet resource of the one or more first internet resources of the first set of request characteristics. Alternatively and/or additionally, it may be determined that the first target revenue value and/or the second expected revenue threshold are associated with the second request for content 636 based upon a determination that the second region matches a region of the one or more first regions of the first set of request characteristics. Alternatively and/or additionally, it may be determined that the first target revenue value and/or the second expected revenue threshold are associated with the second request for content 636 based upon a determination that the second type of client device associated with the second client device 600 matches a type of client device of the one or more first types of client devices of the first set of request characteristics. Alternatively and/or additionally, it may be determined that the first target revenue value and/or the second expected revenue threshold are associated with the second request for content 636 based upon a determination that a user demographic of one or more third user demographics associated with the second user and/or the second client device 600 match a user demographic of the one or more first user demographics of the first set of request characteristics. Alternatively and/or additionally, it may be determined that the first target revenue value and/or the second expected revenue threshold are associated with the second request for content 636 based upon a determination that a second geolocation associated with the second request for content 636 matches a geolocation of the one or more first geolocations of the first set of request characteristics.

In some examples, responsive to receiving the second request for content 636, the database of target revenue values may be analyzed based upon the second request for content 636 to identify the first target revenue value and/or the second expected revenue threshold associated with the second request for content 636. For example, the database of target revenue values may be analyzed based upon one or more of the fourth webpage 644, the second region, the second type of client device, the one or more third user demographics, the second geolocation, etc. to determine that the second request for content 636 is associated with the first target revenue value and/or the second expected revenue threshold.

In some examples, a bidding process may be performed to select a content item from a second plurality of content items participating in an auction for selection of a content item to present via the second client device 600. At 420, a second plurality of bid values associated with the second plurality of content items may be determined (by the backend system 650). A bid value of the second plurality of bid values may be associated with a content item of the second plurality of content items. In some examples, the second plurality of bid values may be determined based upon budgets (e.g., daily budgets) and/or target spend patterns associated with the second plurality of content items. For example, the second plurality of bid values and/or the budgets may be received from devices associated with entities (e.g., advertisers, companies, brands, organizations, etc.) associated with the second plurality of content items.

At 422, a second plurality of expected revenues associated with the second plurality of content items may be determined (by the backend system 650) based upon the second plurality of bid values. An expected revenue of the second plurality of expected revenues may be associated with a content item of the second plurality of content items. In some examples, an expected revenue of the second plurality of expected revenues may correspond to (a prediction of) an amount of revenue that may be received as a result of providing a content item of the second plurality of content items for presentation via the second client device 600 and/or the fourth webpage 644.

In some examples, a second content item 646 (illustrated in FIG. 6F) may be selected from the second plurality of content items for presentation via the second client device 600 and/or the fourth webpage 644 based upon the second plurality of expected revenues. For example, the second content item 646 may be selected from the second plurality of content items for presentation via the second client device 600 and/or the fourth webpage 644 responsive to a determination that a second expected revenue associated with the second content item 646 is higher than expected revenues associated with other content items of the second plurality of content items (and/or that the second expected revenue associated with the second content item 646 is a highest expected revenue of the second plurality of expected revenues).

At 424, whether to present the second content item 646 of the second plurality of content items via the second client device 600 may be determined (by the backend system 650) based upon a comparison 652 of the second expected revenue with the second expected revenue threshold. For example, the second expected revenue associated with the second content item 646 may be compared with the second expected revenue threshold to determine whether the second expected revenue is greater than the second expected revenue threshold or less than the second expected revenue threshold.

In some examples, the second content item 646 may be transmitted to the second client device 600 (and/or the second content item 646 may be provided for presentation via the second client device 600 and/or the fourth webpage 644) responsive to a determination that the second expected revenue associated with the second content item 646 exceeds (and/or is equal to) the second expected revenue threshold. Alternatively and/or additionally, the second content item 646 may not be transmitted to the second client device 600 (and/or the second content item 646 may not be provided for presentation via the second client device 600 and/or the fourth webpage 644) responsive to a determination that the second expected revenue associated with the second content item 646 is less than (and/or equal to) the second expected revenue threshold.

In some examples, the second content item 646 may be transmitted to the second client device 600 (and/or the second content item 646 may be provided for presentation via the second client device 600 and/or the fourth webpage 644) based upon the comparison 652. For example, it may be determined by performing the comparison 652 that the second expected revenue associated with the second content item 646 exceeds the second expected revenue threshold.

FIG. 6F illustrates the second client device 600 presenting and/or accessing the fourth webpage 644 using the browser of the second client device 600. For example, the content system may provide the second content item 646 to be presented via the fourth webpage 644 while the fourth webpage 644 is accessed by the second client device 600.

Implementation of at least some of the disclosed subject matter may lead to benefits including, but not limited to, an increase in instances that content items are presented via client devices responsive to receiving requests for content associated with the one or more first internet resources and/or the first set of request characteristics, an increase in selections of content items presented via the one or more first internet resources responsive to receiving requests for content associated with the first set of request characteristics, an increase in revenue received as a result of the increase in instances that content items are presented via client devices responsive to receiving requests for content associated with the one or more first internet resources and/or the first set of request characteristics, etc. as a result of modifying expected revenue thresholds periodically, as a result of decreasing the first expected revenue threshold to generate the second expected revenue threshold responsive to determining that the first revenue value associated with the first period of time exceeds the first value associated with the first target revenue value such that the second revenue value associated with the second period of time does not exceed the first value by a large difference, etc.

In some examples, at least some of the disclosed subject matter may be implemented on a client device, and in some examples, at least some of the disclosed subject matter may be implemented on a server (e.g., hosting a service accessible via a network, such as the Internet).

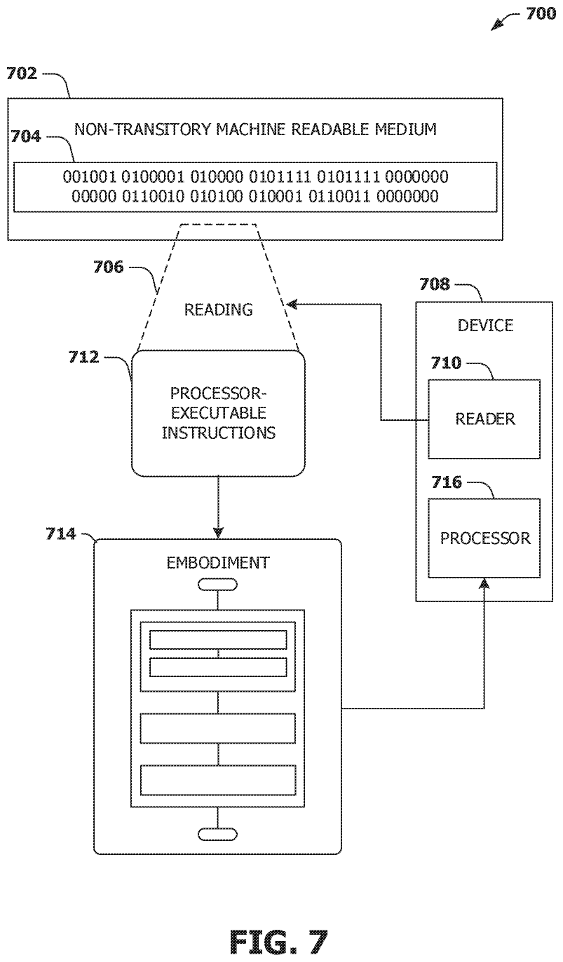

FIG. 7 is an illustration of a scenario 700 involving an example non-transitory machine readable medium 702. The non-transitory machine readable medium 702 may comprise processor-executable instructions 712 that when executed by a processor 716 cause performance (e.g., by the processor 716) of at least some of the provisions herein (e.g., embodiment 714). The non-transitory machine readable medium 702 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disc (CD), digital versatile disc (DVD), or floppy disk). The example non-transitory machine readable medium 702 stores computer-readable data 704 that, when subjected to reading 706 by a reader 710 of a device 708 (e.g., a read head of a hard disk drive, or a read operation invoked on a solid-state storage device), express the processor-executable instructions 712. In some embodiments, the processor-executable instructions 712, when executed, cause performance of operations, such as at least some of the example method 400 of FIGS. 4A-4B, for example. In some embodiments, the processor-executable instructions 712 are configured to cause implementation of a system, such as at least some of the example system 501 of FIGS. 5A-5C, and/or at least some of the example system 601 of FIGS. 6A-6F, for example.

### 3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer and/or machine readable media, which if executed will cause the operations to be performed. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
receiving, during a first period of time, a first request for content associated with a first client device;
determining, based upon the first request for content, that a first expected revenue threshold is associated with the first request for content;
determining a first plurality of bid values associated with a first plurality of content items, wherein a bid value of the first plurality of bid values is associated with a content item of the first plurality of content items;
determining, based upon the first plurality of bid values, a first plurality of expected revenues associated with the first plurality of content items, wherein an expected revenue of the first plurality of expected revenues is associated with a content item of the first plurality of content items;
determining whether to present a first content item of the first plurality of content items via the first client device based upon a comparison of a first expected revenue associated with the first content item with the first expected revenue threshold;
determining a first revenue value associated with presentation of content items via client devices within the first period of time;
modifying, based upon the first revenue value and a target revenue value, the first expected revenue threshold associated with the first request for content to generate a second expected revenue threshold;
receiving a second request for content associated with a second client device;
determining, based upon the second request for content, that the second expected revenue threshold is associated with the second request for content;
determining a second plurality of bid values associated with a second plurality of content items, wherein a bid value of the second plurality of bid values is associated with a content item of the second plurality of content items;
determining, based upon the second plurality of bid values, a second plurality of expected revenues associated with the second plurality of content items, wherein an expected revenue of the second plurality of expected revenues is associated with a content item of the second plurality of content items; and
determining whether to present a second content item of the second plurality of content items via the second client device based upon a comparison of a second expected revenue associated with the second content item with the second expected revenue threshold.

2. The method of claim 1, comprising at least one of:
transmitting the first content item to the first client device responsive to a determination that the first expected revenue associated with the first content item exceeds the first expected revenue threshold; or
transmitting the second content item to the second client device responsive to a determination that the second expected revenue associated with the second content item exceeds the second expected revenue threshold.

3. The method of claim 1, comprising at least one of:
not transmitting the first content item to the first client device responsive to a determination that the first expected revenue associated with the first content item is less than the first expected revenue threshold; or
not transmitting the second content item to the second client device responsive to a determination that the second expected revenue associated with the second content item is less than the second expected revenue threshold.

4. The method of claim 1, wherein at least one of:
the determining the first plurality of expected revenues comprises:
determining a first click probability associated with a third content item of the first plurality of content items, wherein the first click probability corresponds to at least one of a probability of receiving a selection of the third content item responsive to presenting the third content item via the first client device or a probability of receiving a positive signal responsive to presenting the third content item via the first client device; and
determining a third expected revenue associated with the third content item based upon the first click probability and a third bid value, of the first plurality of bid values, associated with the third content item; or
the determining the second plurality of expected revenues comprises:
determining a second click probability associated with a fourth content item of the second plurality of content items, wherein the second click probability corresponds to at least one of a probability of receiving a selection of the fourth content item responsive to presenting the fourth content item via the second client device or a probability of receiving a positive signal responsive to presenting the fourth content item via the second client device; and
determining a fourth expected revenue associated with the fourth content item based upon the second click probability and a fourth bid value, of the second plurality of bid values, associated with the fourth content item.

5. The method of claim 1, wherein at least one of:
a third expected revenue, of the first plurality of expected revenues, associated with a third content item of the first plurality of content items, corresponds to a third bid value of the first plurality of bid values; or
a fourth expected revenue, of the second plurality of expected revenues, associated with a fourth content item of the second plurality of content items, corresponds to a fourth bid value of the second plurality of bid values.

6. The method of claim 1, wherein:
the target revenue value corresponds to at least one of:
a target average revenue per content item presentation; or
a target average revenue per multiple content item presentations; and
the first revenue value corresponds to at least one of:
an average revenue per content item presentation associated with the presentation of the content items via the client devices within the first period of time; or
an average revenue per multiple content item presentations associated with the presentation of the content items via the client devices within the first period of time.

7. The method of claim 6, wherein:
the modifying the first expected revenue threshold to generate the second expected revenue threshold comprises at least one of:
increasing the first expected revenue threshold to generate the second expected revenue threshold based upon a determination that the first revenue value is less than a first value associated with the target revenue value; or
decreasing the first expected revenue threshold to generate the second expected revenue threshold based upon a determination that the first revenue value exceeds the first value associated with the target revenue value.

8. The method of claim 7, wherein:
the first value associated with the target revenue value is equal to the target revenue value.

9. The method of claim 7, wherein:
the first value associated with the target revenue value is greater than the target revenue value.

10. The method of claim 1, wherein:
the first expected revenue threshold and the second expected revenue threshold are associated with a first set of request characteristics indicative of at least one of:
an internet resource;
a region;
a type of client device; or
one or more user demographics.

11. The method of claim 10, wherein at least one of:
the determining that the first expected revenue threshold is associated with the first request for content comprises at least one of:
determining, based upon the first request for content, that a first internet resource associated with the first request for content matches the internet resource of the first set of request characteristics;
determining, based upon the first request for content, that a first region associated with the first request for content matches the region of the first set of request characteristics;
determining, based upon the first request for content, that a first type of client device of the first client device matches the type of client device of the first set of request characteristics; or
determining, based upon the first request for content, that one or more first user demographics associated with the first client device match the one or more user demographics of the first set of request characteristics; or
the determining that the second expected revenue threshold is associated with the second request for content comprises at least one of:
determining, based upon the second request for content, that a second internet resource associated with the second request for content matches the internet resource of the first set of request characteristics;
determining, based upon the second request for content, that a second region associated with the second request for content matches the region of the first set of request characteristics;
determining, based upon the second request for content, that a second type of client device of the second client device matches the type of client device of the first set of request characteristics; or
determining, based upon the second request for content, that one or more second user demographics associated with the second client device match the one or more user demographics of the first set of request characteristics.

12. The method of claim 11, wherein:
the presentation of the content items via the client devices within the first period of time comprises a content item being presented via a client device within the first period of time; and
the content item is presented via the client device responsive to receiving a request for content associated with the first set of request characteristics.

13. The method of claim 1, wherein at least one of:
the first expected revenue associated with the first content item is a highest expected revenue of the first plurality of expected revenues; or
the second expected revenue associated with the second content item is a highest expected revenue of the second plurality of expected revenues.

14. A computing device comprising:
a processor; and
memory comprising processor-executable instructions that when executed by the processor cause performance of operations, the operations comprising:
determining a first revenue value associated with presentation of content items via client devices within a first period of time;
generating, based upon the first revenue value, a target revenue value and a first expected revenue threshold associated with the first period of time, a second expected revenue threshold;
receiving a first request for content associated with a first client device;
determining, based upon the first request for content, that the first request for content is associated with the second expected revenue threshold;
determining a first plurality of bid values associated with a first plurality of content items, wherein a bid value of the first plurality of bid values is associated with a content item of the first plurality of content items;
determining, based upon the first plurality of bid values, a first plurality of expected revenues associated with the first plurality of content items, wherein an expected revenue of the first plurality of expected revenues is associated with a content item of the first plurality of content items; and
determining whether to present a first content item of the first plurality of content items via the first client device based upon a comparison of a first expected revenue associated with the first content item with the second expected revenue threshold.

15. The computing device of claim 14, the operations comprising:
transmitting the first content item to the first client device responsive to a determination that the first expected revenue associated with the first content item exceeds the second expected revenue threshold.

16. The computing device of claim 14, the operations comprising:
not transmitting the first content item to the first client device responsive to a determination that the first expected revenue associated with the first content item is less than the second expected revenue threshold.

17. The computing device of claim 14, wherein at least one of:
the determining the first plurality of expected revenues comprises:
determining a first click probability associated with a second content item of the first plurality of content items, wherein the first click probability corresponds to at least one of a probability of receiving a selection of the second content item responsive to presenting the second content item via the first client device or a probability of receiving a positive signal responsive to presenting the second content item via the first client device; and
determining a second expected revenue associated with the second content item based upon the first click probability and a second bid value, of the first plurality of bid values, associated with the second content item; or
a third expected revenue, of the first plurality of expected revenues, associated with a third content item of the first plurality of content items, corresponds to a third bid value of the first plurality of bid values.

18. A non-transitory machine readable medium having stored thereon processor-executable instructions that when executed cause performance of operations, the operations comprising:
receiving, during a first period of time, a first request for content associated with a first client device;
determining, based upon the first request for content, that a first expected revenue threshold is associated with the first request for content;
determining a first plurality of bid values associated with a first plurality of content items, wherein a bid value of the first plurality of bid values is associated with a content item of the first plurality of content items;
determining, based upon the first plurality of bid values, a first plurality of expected revenues associated with the first plurality of content items, wherein an expected revenue of the first plurality of expected revenues is associated with a content item of the first plurality of content items;
determining whether to present a first content item of the first plurality of content items via the first client device based upon a comparison of a first expected revenue associated with the first content item with the first expected revenue threshold;
determining a first revenue value associated with presentation of content items via client devices within the first period of time; and
modifying, based upon the first revenue value and a target revenue value, the first expected revenue threshold associated with the first request for content to generate a second expected revenue threshold.

19. The non-transitory machine readable medium of claim 18, the operations comprising:
receiving a second request for content associated with a second client device;
determining, based upon the second request for content, that the second request for content is associated with the second expected revenue threshold;
determining a second plurality of bid values associated with a second plurality of content items, wherein a bid value of the second plurality of bid values is associated with a content item of the second plurality of content items;
determining, based upon the second plurality of bid values, a second plurality of expected revenues associated with the second plurality of content items, wherein an expected revenue of the second plurality of expected revenues is associated with a content item of the second plurality of content items; and
determining whether to present a second content item of the second plurality of content items via the second client device based upon a comparison of a second expected revenue associated with the second content item with the second expected revenue threshold.

20. The non-transitory machine readable medium of claim 19, the operations comprising at least one of:
transmitting the first content item to the first client device responsive to a determination that the first expected revenue associated with the first content item exceeds the first expected revenue threshold; or
transmitting the second content item to the second client device responsive to a determination that the second expected revenue associated with the second content item exceeds the second expected revenue threshold.
